(19) United States
(12) Patent Application Publication
(10) Pub. No.: US 2025/0159085 A1
(43) Pub. Date: May 15, 2025

(54) METHODS AND SYSTEM FOR CREATING PRINTABLE PHOTOBOOKS AND MANAGING MEDIA

(71) Applicant: Boyd Pearce, SARATOGA, CA (US)

(72) Inventor: Boyd Pearce, SARATOGA, CA (US)

(21) Appl. No.: 18/506,471

(22) Filed: Nov. 10, 2023

(51) Int. Cl. H04N 1/00; H04L 9/40

(52) U.S. Cl. CPC H04N 1/00196; H04L 63/0853; H04L 63/18; H04N 1/00392; H04N 1/0044

(57) ABSTRACT

Methods and systems of composing printable photobooks on a mobile user device without uploading the original photos used to create the photobook to the publisher are disclosed. In one embodiment, the present invention creates an automatic page preview canvas and template, ribbon including selected photos and buttons for options. Photos are added to the template and swapped by tapping the template slot and photo. The ribbon hides photos added and unhides removed. The user change templates, backgrounds, page order and add pages and text. Selecting photos accelerates by photos displayed chronologically by recent, calendar date, geographic locations and albums. Full page photos rendered to the publisher book size and printing specifications are uploaded to assure photobook quality. The system utilizes a distributed database coupled with an EU-GDPR compliant network to securely message and share photobooks and photos to family, friends and groups with one or more user mobile devices.

### BACKGROUND OF THE INVENTION

The proliferation of photos, videos and the integration of textual data, audio, graphics and animation into multimedia has created a modern problem-how to effectively manage and organize large volumes of digital content so it can be simply accessed and composed into meaningful results such as photobooks. This problem is further exacerbated by the lack of effective mobile methods that enable users to quickly find their favorite digital content and the complexity of operating proprietary client-server apps provided by publisher to compose and print high-quality photobooks.

Today, users have no way to directly find desired digital content on their devices and struggle remembering if the targeted content resides on their smartphone, tablet or in online storage repositories. Furthermore, when confronted by proprietary publisher apps, users are often frustrated by the graphical skill-level and development time required to compose and publish a high-quality photobook. The invention solves these shortcomings by providing executable code that deploys multiple optimized methods to organize and find desired digital content on smartphones and tablets, regardless of its location. Likewise, the invention provides code to simplify composing and publishing high-quality photobooks by processing photos, pages, and templates on mobile devices without uploading the original photos used to create the photobook to a publisher. Code is also included to integrate a broad spectrum of data types into the final photobook product that can be printed at leading publishers, viewed and shared with family, friends and groups.

Messaging and sharing information, photos and photobooks over one or more devices coupled to a network with family, friends and groups exposes all to email and messaging hacks, spam attacks and privacy violations that can have serious consequences. The invention enables users to connect directly with family, friends and groups through accepted invitations that allows users to be anonymous and secure on a private network without exposing any contact information and receiving notifications, messages and content only from invited and connected users.

### SUMMARY OF THE INVENTION

Unsolved problems in smartphones and tablets for creating a high-quality photobook, by processing photos, pages, and templates are resolved by the present invention. The invention describes a thorough methodology for creating a photobook on a mobile phone or tablet running iOS, iPadOS and Android operating systems and printing the photobook at a publisher by composing, rendering and uploading one photo per page and not uploading the original photos used to create the photobook. The method indexes all device photos by recent additions, calendar date, location and activities to shorten the time to populate the photobook photo ribbon and a tap of the template photo slot and ribbon photo, adds to the page encoding and renders an immediate preview. Buttons add pages and text, change templates and background, and reorder pages, all rendering an immediate preview. Printing the photobook is accomplished by selecting a publisher and photobook size, rendering full-page photos, uploading the photos and authorizing printing.

Unsolved problems in smartphones and tablets for organizing, displaying and selecting photos for creating a high-quality photobook are resolved by the present invention. The invention describes a thorough methodology for automatically indexing existing and each new photo, creating one or more composed and rendered daily memory photos and an interface to allow a user to display and select one or more photos to create a photobook, tag into albums, hide, and automatically compose and render photos for sharing, posting and play as multimedia by a mobile user device having a mobile device operating system. This method creates an automatic home page for displaying recent photos chronologically ordered and by tapping buttons to display photos by, a calendar date, location or daily memory photo collection. The method also provides system smart albums which are automatically created and user albums created at any time that contain metadata and media that is tagged to the album in folders and as favorites. Further, the method assigns all media a custom datatype tag to one or more albums with tag separators and individual albums' tag that contains metadata such as folder ID, favorite status and special album encoding

Unsolved problems in smartphones, tablets, laptops and desktops for messaging and sharing photobooks, photos and information to family, friends and groups over one or more user devices having iOS, iPadOS, macOS, Android, ChromeOS or Windows operating system coupled to the network are resolved by the present invention. The invention comprises a database coupled to the network to receive user multimedia content and other data, multi-factor authentication login that enables user to send and accept invitations with credentials to connect users and add user connections to network database with services enabling users to send, receive and forward notifications to one or more users. This method creates a private social network that protects user identity, privacy and personal media by deploying a distributed database with a collection of anonymous hidden global ID's that shields the user, user albums and distributed media from anyone not directly connected to the user over the network. This method also provides invitation management that after acceptance, connects user to individuals, family members and group members using nicknames and network credentials to connect participants and support the creation of distributed albums.

The invention describes a thorough methodology for processing and managing a multitude of photos. This process includes receiving photos from multiple sources of media, sorting and indexing chronologically by inserting them into an auto-increment media table. These photos are then asynchronously indexed chronologically by calendar date, by geographic locations, by feature recognition using album examples and daily memory displays for seamless viewing and organization into smart albums and photobooks. Additional features include tagging, sharing, and hiding photos, as well as establishing a unique identifier for each photo. The method also includes the development of an efficient system for identifying and integrating new photos, based on comparison of photo dates. These photos are then confirmed for existence, not a duplicate and then added to the media album to manage and process.

The invention describes how media retrieval speed, media selection options, smart albums, media streaming and distributed functions are enabled by indexing, the album ID, the tag custom datatype, the global unique identifier and other family, album and media data. The invention also describes how the mobile app composer and publisher use these and other innovations to revolutionize the creation and publishing of printed photobooks and other digital multimedia projects.

Further aspects of the invention entail storing photos in a distributed database capable of managing a large quantity of photos per device, and providing unique and secure global identifiers for each photo. The method also includes provisions for conformity with General Data Protection Regulation (GDPR) through a secure private social network. Lastly, a mobile app composer and publisher to add to the photo's value is also provided.

As used herein, a photo is a digital or physical photo that captures a moment in time. It is a still photo, a video, or a GIF and encompasses all forms of visual media including multimedia files such as Video, Animation, Audio file format, Interactive media, Video game, Computer animation, Audio Video Interleave, Hypermedia, Infographic, Photograph, Vector graphics. These are just a few examples of the many ways that photo content or a graphics medium used to capture and share moments in time. As technology continues to evolve, other forms of multimedia contents are contemplated.

Advantages of the above aspects may include one or more of the following. The operations can improve computer performance as follows:
a. The operations described in the method aim to enhance computer performance by optimizing photo storage, retrieval, and display processes. These improvements can lead to a more efficient and user-friendly experience.
b. Indexing the photos based on calendars, geographic location, feature recognition and daily memory displays allows for quick and efficient retrieval of photos based on date and time or other methods. Proper indexing can significantly speed up the process of searching for specific photos and displaying them in photobooks, albums or memory displays.
c. By performing the indexing process asynchronously after software installation, the user experience can be enhanced. Asynchronous operations allow users to continue using the software without waiting for any time-consuming indexing tasks to complete.
d. Displaying photos in a home album for selection, tagging, sharing, or hiding provides a user-friendly interface to manage their photo collection. An efficient home album display ensures smooth and responsive interactions with the photos, contributing to an overall improved user experience.
e. Indexing the media library into the calendar display streamlines the process of finding, displaying, tagging, and sharing photos. This indexing enables users to quickly identify and share photos based on specific events or dates, enhancing performance and user productivity.
f. Geographical clustering of photos can be useful for creating memory photobooks with photos captured in specific locations. By organizing photos in this way, accessing and displaying photos related to a particular location becomes faster and more efficient.
g. The method described includes identifying new photos and inserting them into the media library without duplication. This efficient process ensures that only new photos are added, reducing unnecessary processing and storage overhead and user dissatisfaction.
h. Linking photos in a distributed database allows for better scalability and performance. The distributed nature of the database enables rapid sharing, reconfiguration, and updating of photos, leading to improved overall system responsiveness.
i. Assigning each photo a unique and secret global identifier ensures secure and efficient access to specific photos without revealing any personal contact information. This approach can simplify photo retrieval and maintain the source.
j. By adhering to General Data Protection Regulation (GDPR) compliance, the method ensures that user data and photos are handled responsibly and securely. This can help build trust among users and maintain a positive user experience.
k. Providing a mobile app composer and publisher simplifies the process of adding value to photos on mobile devices. This can include editing, composing photobooks, and publishing enhanced photos, contributing to a more seamless user experience.
l. Having Home photos displayed by current photo date displays the last photo received first.
m. Changing photos current date to creation date when tagged to user Albums displays photos in the order most important to users.

Yet other advantages of the invention may include one or more of the following:
Organizing, indexing, and displaying photos in an intuitive way
Easily accessible storage for media that can be shared with others
A chronological method of viewing photos
Seamless integration of new photos into existing library
Tagging and Hiding of photos to easily locate desired photos
Unique identifier for each photo

### BRIEF DESCRIPTION OF DRAWINGS

Turning now descriptively to the drawings, in which similar reference characters denote similar elements throughout the several views, the figures illustrate the electronic look of the present invention. With regard to the reference numerals used, the following numbering is used throughout the various drawing figures.

FIG. 1 shows an exemplary illustration of a processing photos into photobooks.

FIG. 2 shows an exemplary image of user interface and architecture.

FIGS. 3A-3B show an exemplary media management system overview.

FIGS. 4A-4B show exemplary indexing methods to improve system performance.

FIG. 5 shows an exemplary illustration of tag custom datatype to speed up database performance and app functionallity

FIGS. 6A-6L illustrates details of the photobook method.

FIGS. 7A-7B show Home media management and distributed network management examples

FIGS. 8A-8B show the Family Tree automatic expansion and sharing with automatic reconfiguration for each family member

FIGS. 9A-9B show smart album types and context provided for unique behavior.

FIG. 10 shows exemplary uses of Gobal Unique ID

FIG. 11 shows exemplary private network data structures in the system to improve computer performance.

### DETAILED DESCRIPTION OF THE INVENTION

The following discussion describes in detail one embodiment of the invention (and several variations of that embodiment). This discussion should not be construed, however, as limiting the invention to those particular embodiments, practitioners skilled in the art will recognize numerous other embodiments as well. For definition of the complete scope of the invention, the reader is directed to appended claims.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

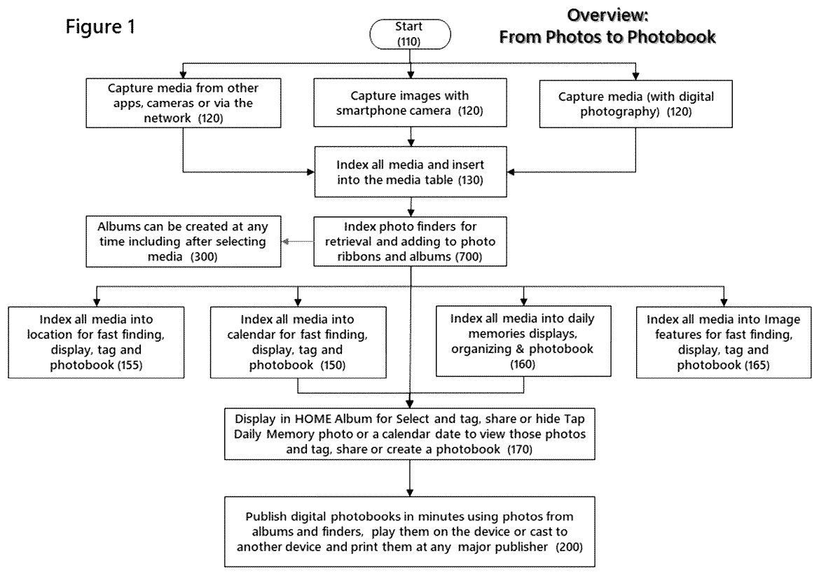

FIG. 1 shows an exemplary illustration of processes to handle photos as photobooks which can be published in printed and digital formats. The method begins with receiving a plethora of photos 120 from various media platforms including but not limited to digital cameras, smartphones, cloud storage, social media platforms, and other similar sources. The received photos are then 130 indexed and added to a dedicated media table and 140 indexed for streamlined management and quick retrieval. The system of FIG. 1 is adapted for processing a plurality of photos by:
receiving the photos from a plurality of media 120;
adding photos to a media database table 130;
indexing photos in the media table by date 140;
create family, friend and personal albums 300;
indexing the photos in the media table by:
   indexing the photos into one or more calendars 150 for finding, displaying and tagging of the photos in one or more photobooks;
   indexing the photos into one or more photo features 165 for finding, displaying and tagging of the photos in one or more photobooks;
   indexing the photos into one or more geographic locations 155 for finding, displaying and tagging of the photos in one or more photobooks;
   indexing the photos into one or more daily memory 160 displays for viewing and organizing in one or more photobooks; and
Display photos in Home 170 prepared to Tag, Share & Hide media and publish photobooks 200

In addition, the method involves the creation of a ‘home album’ 170. This feature could refer to a primary or default view of the indexed photos, showcasing most recent, most viewed, or prioritize photos based on user preferences or system algorithm. In the “home album” after indexing, the content is available for rapid tagging, showing and sharing. The user can compose 200 a photobook in minutes, or from a home page or a calendar can compose the selected media. The daily memory can be shared or a photo story can be composed. The composed media is tagged to an album for rapid finding, showing and playing a collection of related media. The system can also import media and tag from the cloud or data storage devices, and the system can automatically tag 170 shared media to the recipient album. The user can tag photos or streaming media, among others.

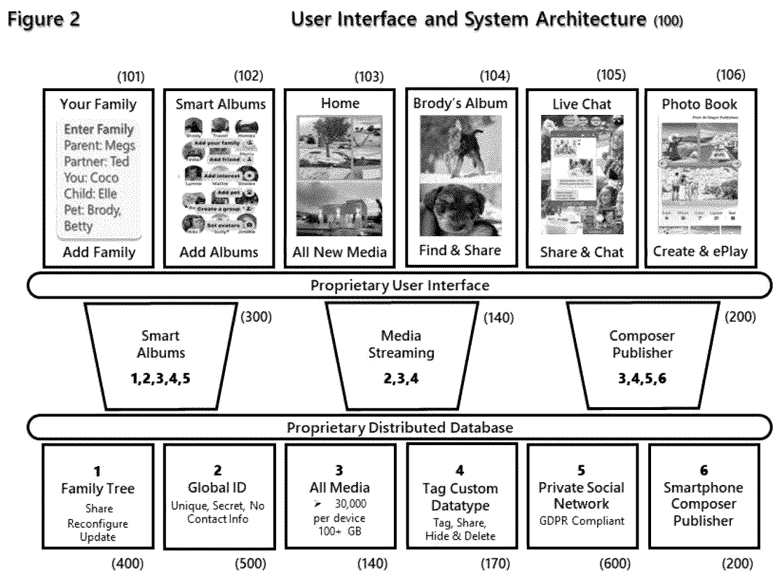

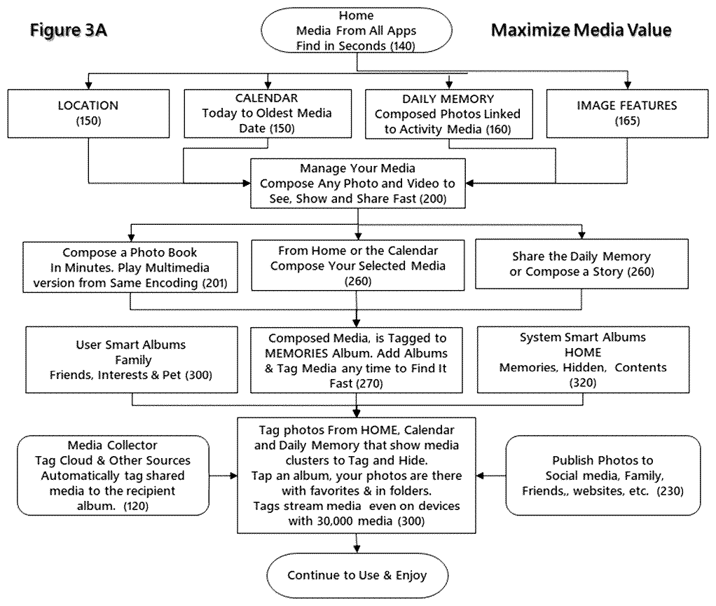

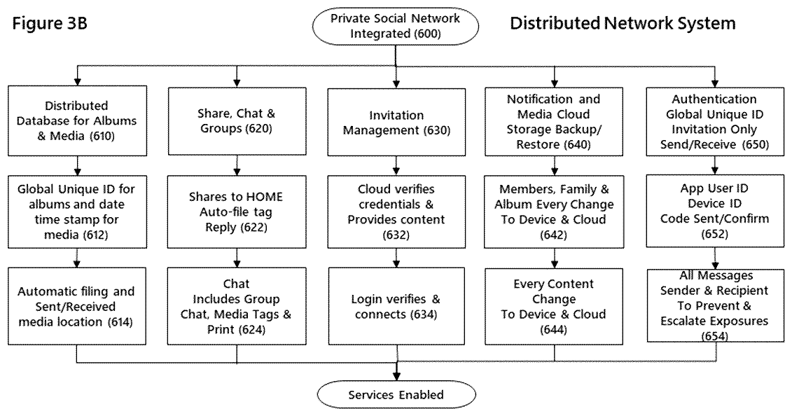

FIG. 2 shows an exemplary illustration of the user interface and system architecture building blocks, which enable users to automatically retrieve, curate, organize, tag, share, and publish photos and other multimedia output. Optimized to be intuitive and efficient, each of the building blocks will be described in the following paragraphs to provide an overview of how they interoperate and relate to the referenced FIGS. 3A-11.

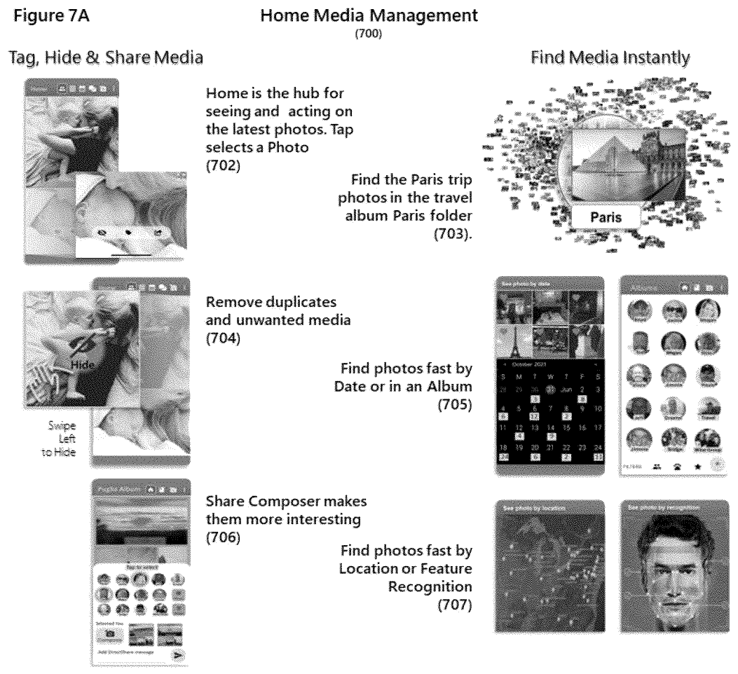

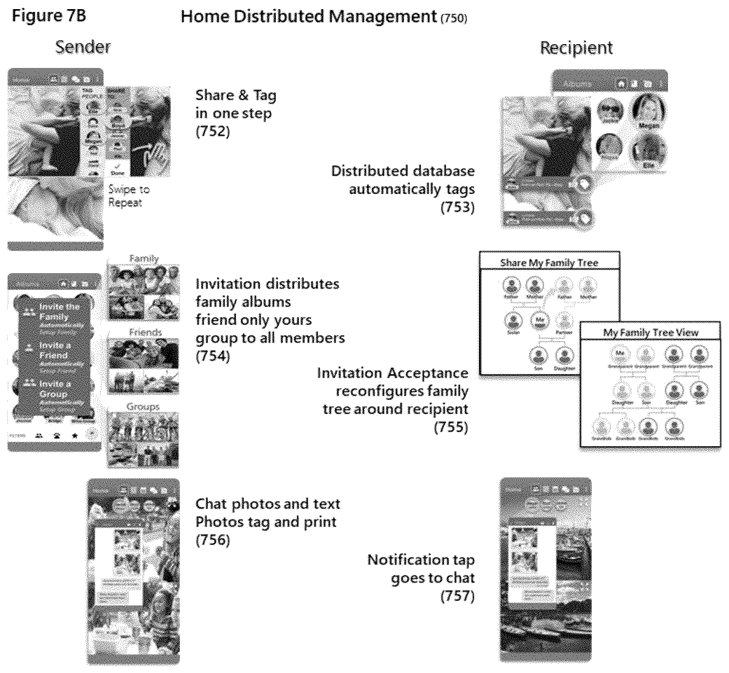

The User Interface (GUI) can provide an easy-to-use Home platform FIG. 7A for users to view their own photos, as well as those of other users. Additionally, users can comment on each other's photos and chat FIG. 7B about them. The comments can be posted publicly or privately, depending on the user's preference. In one embodiment, the GUI also provides a “like” button that allows users to “like” each other's photos. This feature can be used to indicate appreciation for a photo or collection of photos, as well as to increase the visibility of certain photos or collections.

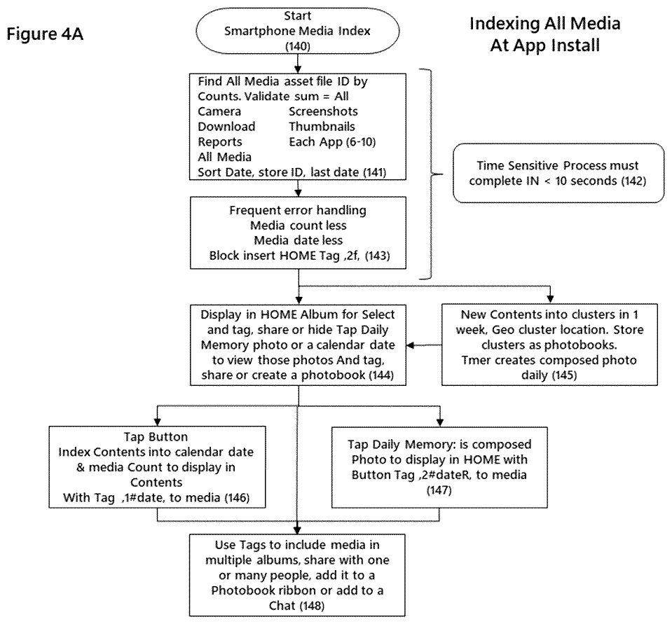

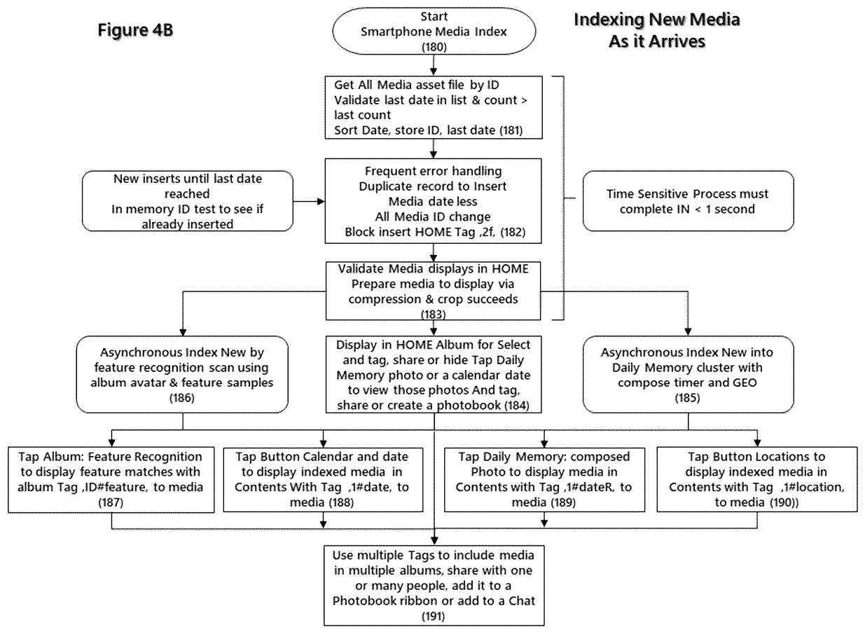

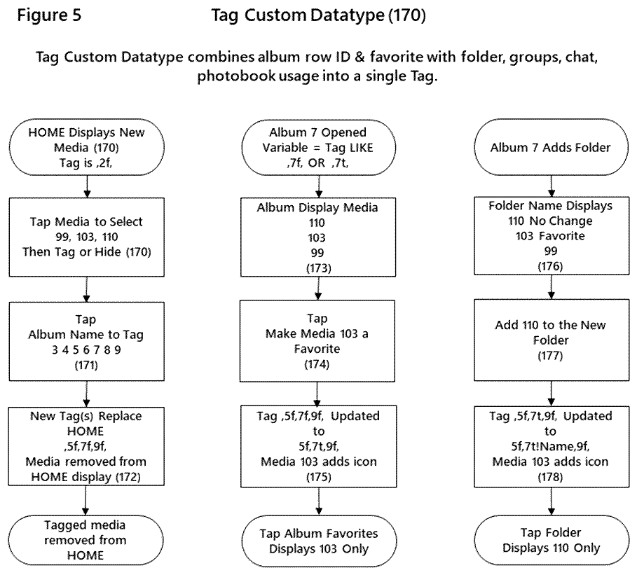

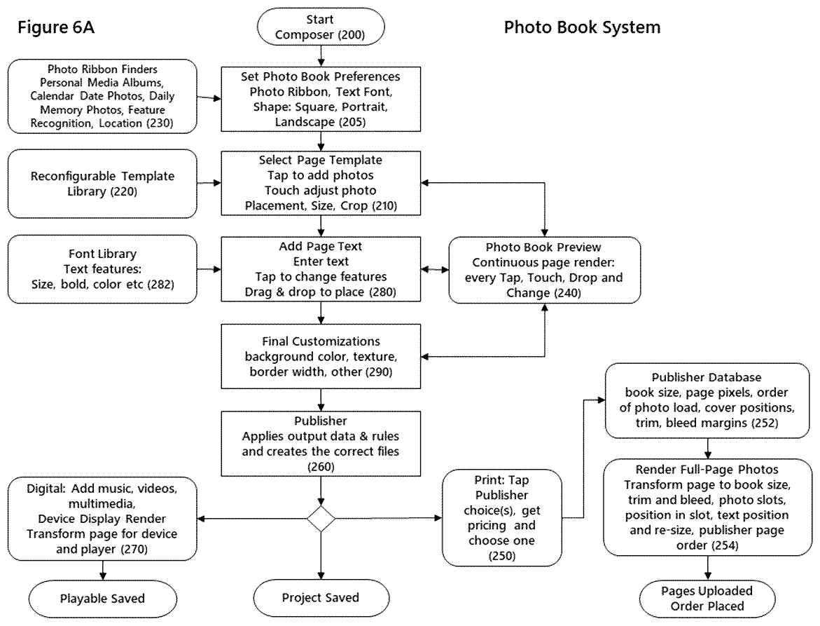

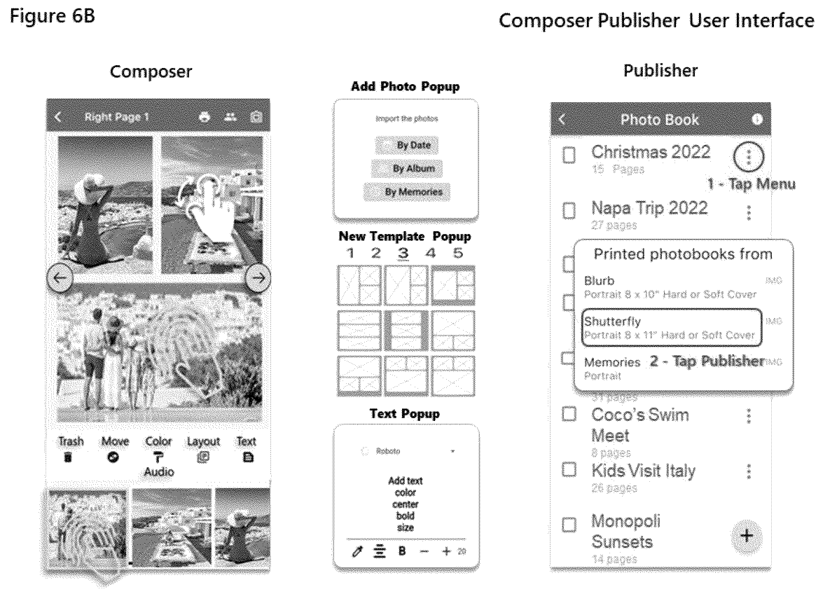

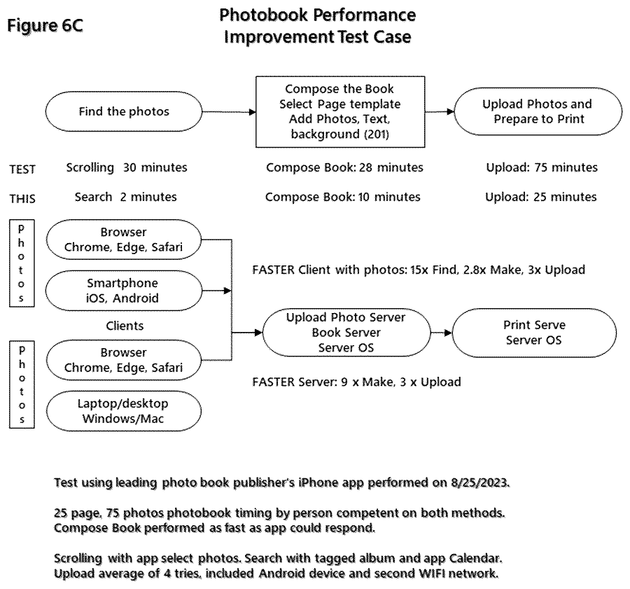

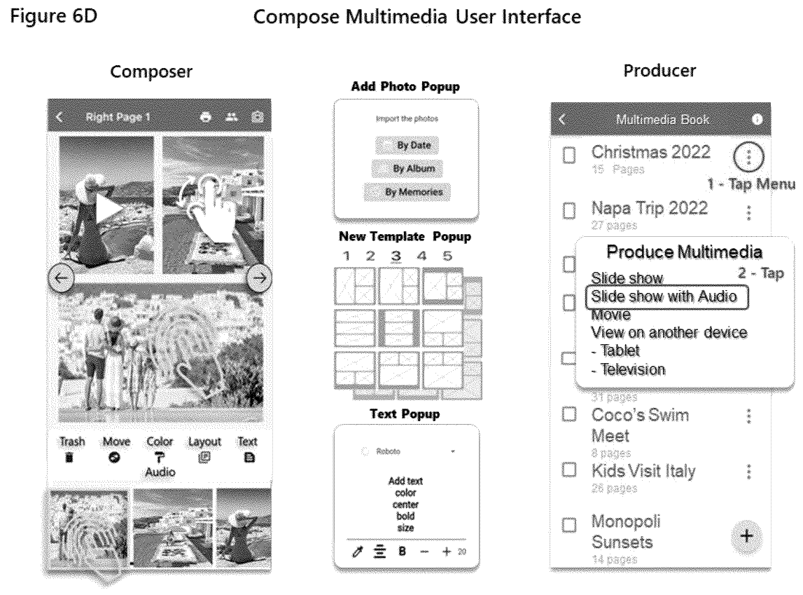

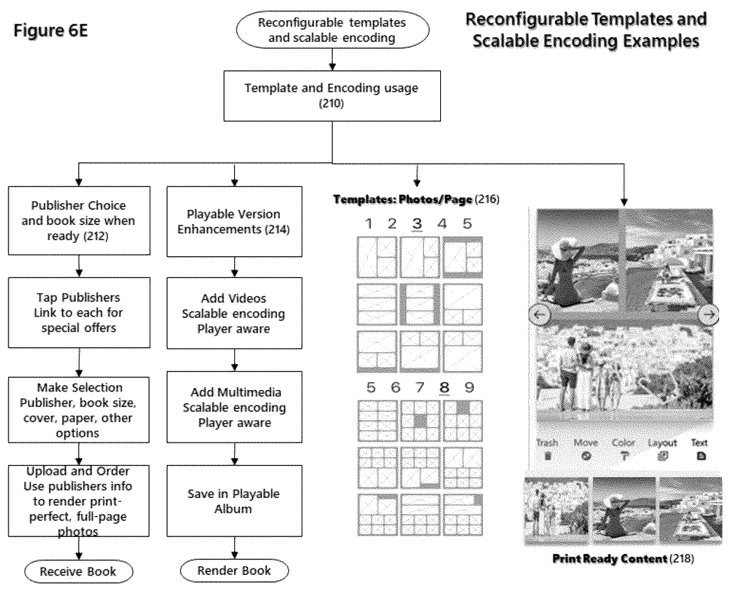

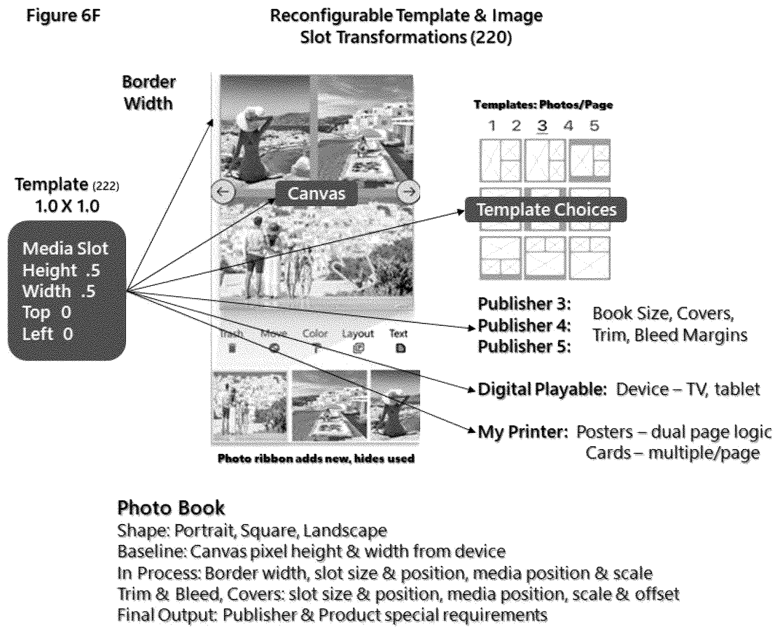

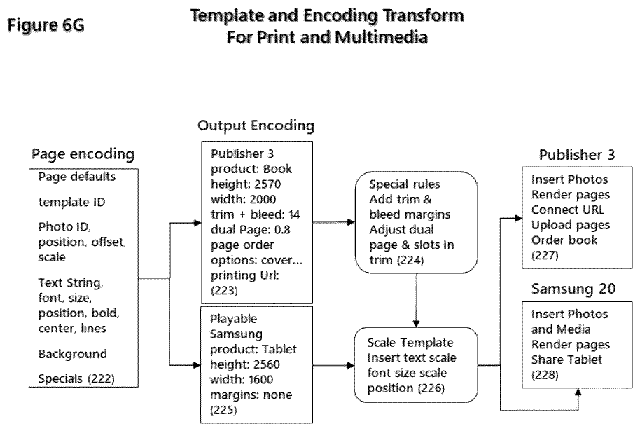

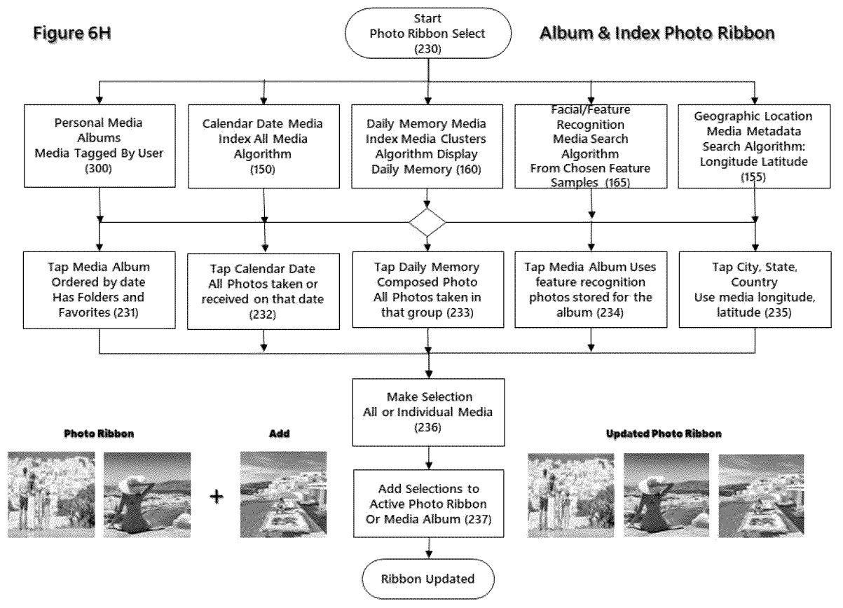

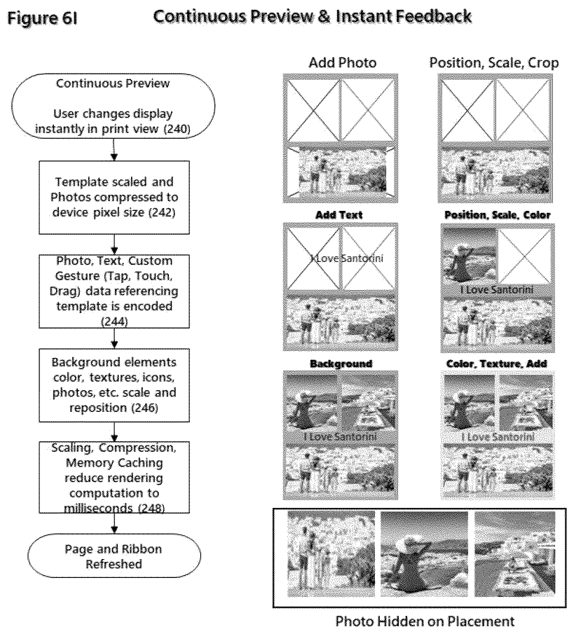

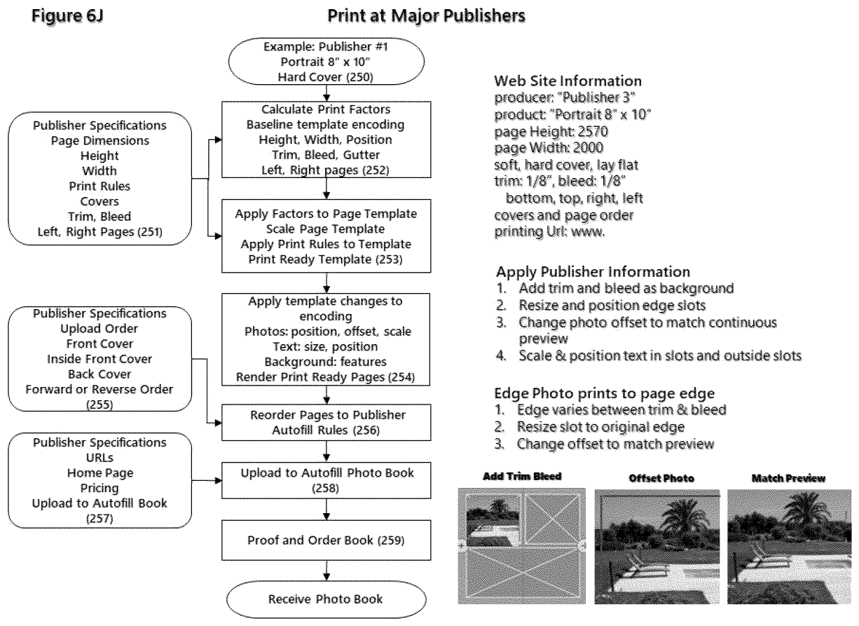

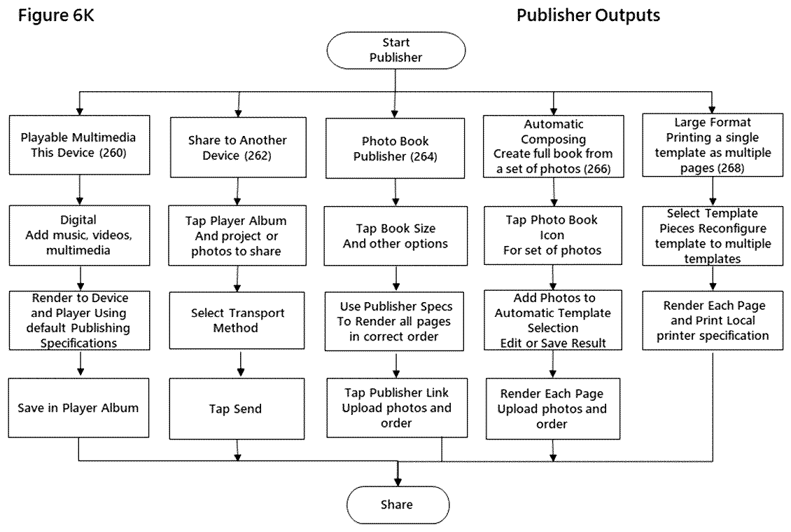

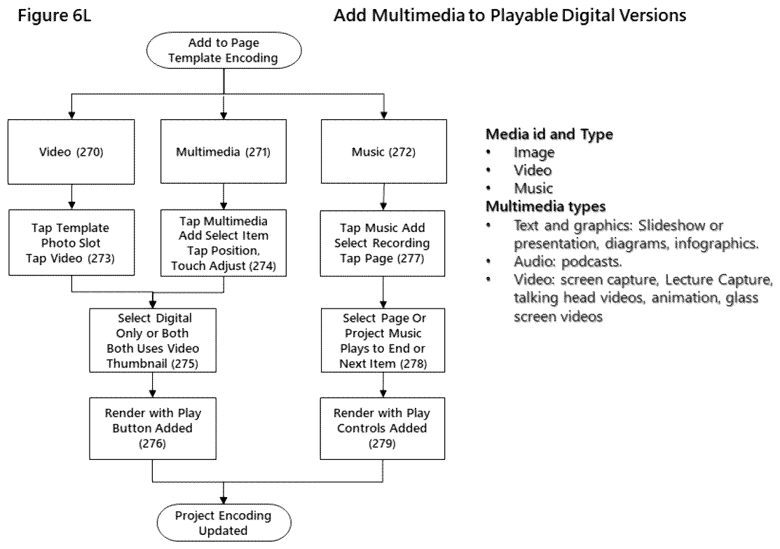

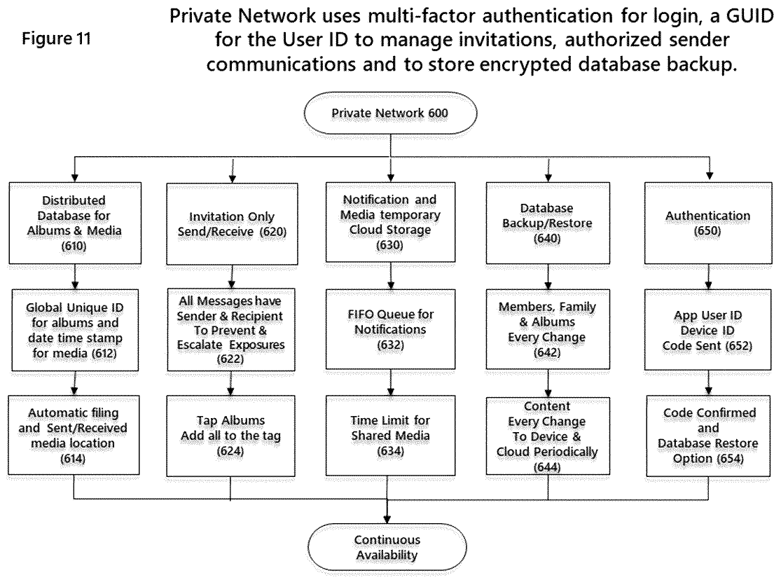

The system includes photo organization FIG. 4B and publishing functions such as automatic photo collection, curation, organization, tagging, storage, and publishing. The user can select one or more photo collections to retrieve photos from, and the user interface automatically organizes the photos based on predetermined criteria. There are also various options for tagging FIG. 5 the photos, including manual and automatic tagging options. The user interface is provided to handle smart albums and streaming media with tools such as a composer/publisher FIG. 6A, all of which are supported by a distributed database FIG. 11. It allows the user to view, organize, and manage the retrieved photos. The user interface also allows the user to share the photos with others via social media, email, or other forms of communication. Furthermore, the interface may allow the user to create customized photobooks or publications using the retrieved photos. The processor then processes the analyzed photos to determine the most relevant tags and categories for the photos. These tags and categories are used to organize the photos into different albums, folders, or collections.

All Media indexing system FIGS. 4A-4B provides users immediate photo access to each day, to activities and events, to locations and to photo features ready to stream, tag into albums FIG. 5 and quickly compose into a share, a printed photobook or a multimedia playable file FIGS. 6A-6J.

Composer Publisher FIGS. 6A-6J includes a photo organizer module, a composer module and a publishing module. The photo organizer module automatically retrieves, curates, organizes and tags photos from multiple sources. The composer module automatically or lets the user manually create the photobook pages from photos in the organizer module. The publishing module allows users to easily share or publish the composed photos.

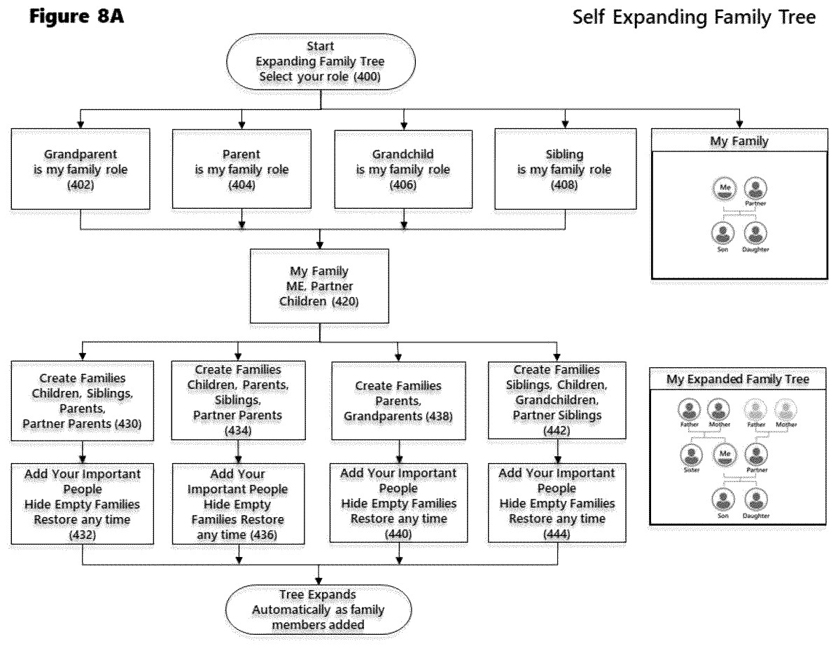

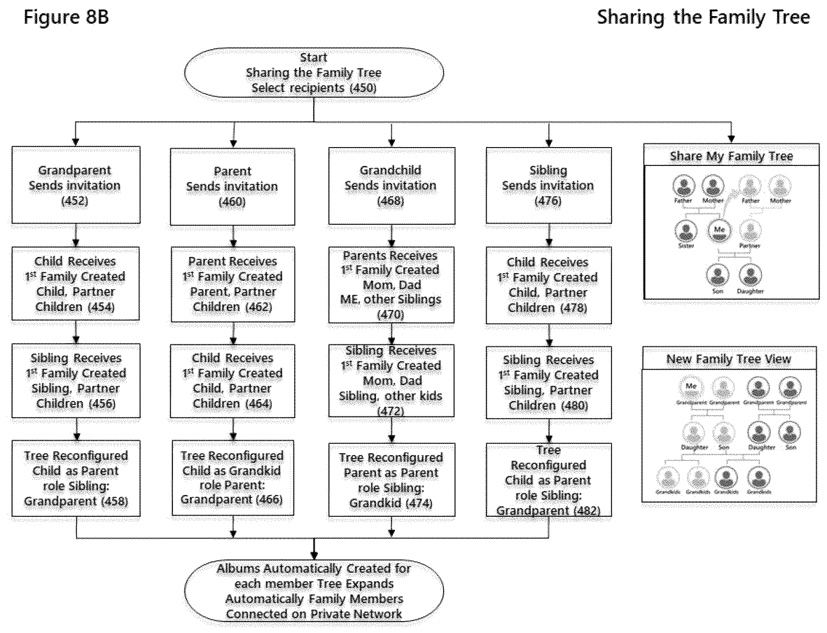

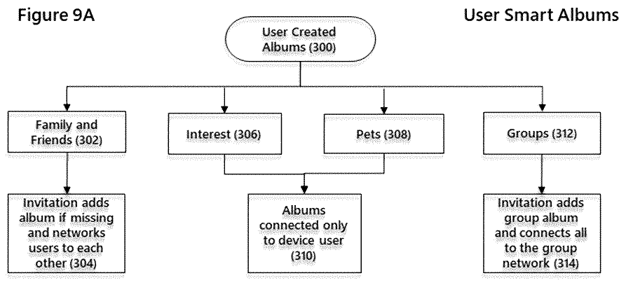

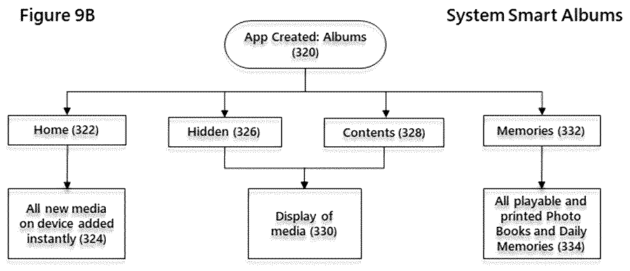

Smart Albums FIGS. 9A-9B create curated collections of media organized by family, friends, pets and interests ready to show, play, share, compose and publish. Family Tree FIGS. 8A-8B captures roles and relationships that can be shared with other family members and automatically reconfigures the tree roles and relationships for each family member as the tree expands or contracts and establishes 1-to-1 and 1-many connections for logged in family members.

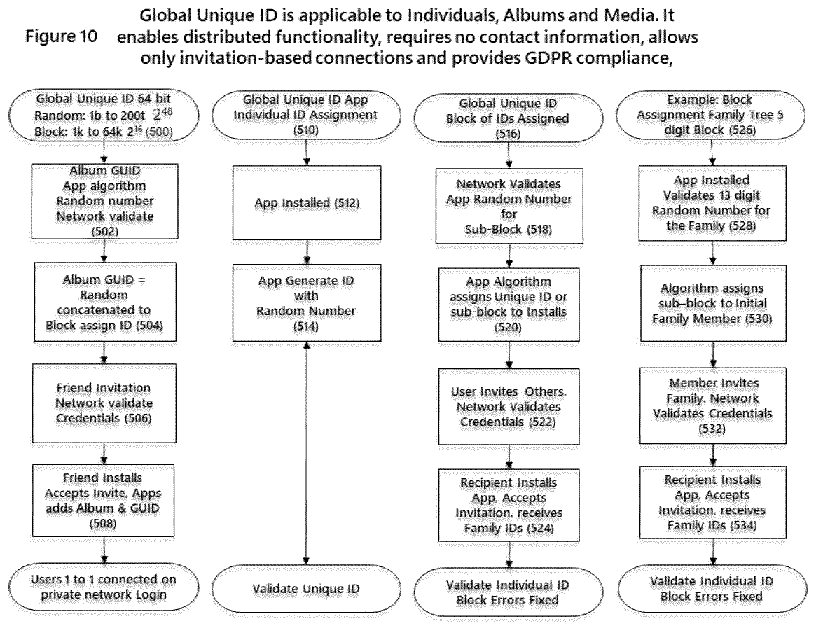

Private Social Network FIG. 11 leverages 1) multi-factor authentication, 2) user anonymity requiring only nicknames, 3) distributed database of albums and media with global unique ID FIG. 10, prevents unknown senders, fake notifications and spam with invitation based connections, 4) temporary storage for notifications and shared media until downloaded by recipient, which prevents disruptions by device failure, 5) adds new devices with database backup, and is GDPR compliance.

FIG. 3A shows exemplary illustration of processes to maximize the value of media management. The media collector module 120 enables users to select digital photos from a variety of sources, including online websites, file systems, databases, and/or other photo repositories. The media collection module may also provide functionality for users to upload photos from their personal devices, such as mobile phones, tablets, laptops, and/or desktop computers.

Home 140 has all new photos immediately and the indexing by calendar date 150, locations 155, photo features 165 and displays daily composed photos of past memorable activities 160 to optimize user accessibility and navigation of all photos. Smart albums 400 and a unique tagging method 300 make organizing photos fast and efficient and the hide tag 320 removes unnecessary photo clutter. Tagging means that each photo is associated with the date of its creation not the last save, thereby providing a chronological organization of photographs for easy discovery, tagging, and display. Tap an album and see all the photos. Tap a calendar date and see all for that date. Go forward or back with a tap or choose a different date. Tap the Daily Memory composed photo and see all the photos. Tap album features and see the latest feature recognition finds. Tap a location and see photos from that location.

Composing photos 200 into printed photobooks, enriching a share or creating playable multimedia is fast for any photos. Composed photos are tagged to the memory's album. Photos can be shared, streamed and played 300 from any album.

FIG. 3B shows exemplary illustration of processes that require the distributed network system 600. authentication 650, notifications and cloud storage 640, Invitations to family and friends 630, chat and groups 620, distributed database 610 are the major processes. Distributed database photos may be organized and categorized based on various criteria, such as content, location, date/time, tags, user preferences, etc. Photos can then be published to social media platforms, websites, or other outlets, such as online galleries or photo sharing services. Furthermore, users can also search for photos within the distributed database, and can filter their searches by various criteria, such as date/time, location, content, tags, etc. In some embodiments, users may also have the ability to rate, comment, and/or edit photos stored in the distributed database.

FIGS. 4A-4B show exemplary illustration of processes for initial and ongoing media indexing to the media table The method abstracts the complexity of photo organization and offers a comprehensive solution to manage and enjoy photos and the illustration provides more details of the indexing architecture to improve computer performance. From a plethora of media storage sites available to a user, tracking new photos and managing them can pose considerable challenges. The pictures taken, downloaded, or received can easily get scattered across different folders making it difficult to locate or manage effectively. Tracking the date of photo generation or download can help keep tabs on newly acquired photos. This technique takes advantage of the metadata associated with photos which retains information about photo generation or download date to effectively identify, organize and manage newly added photos.

FIG. 4A shows exemplary illustration of indexing processes to improve computer performance. INDEX ALL normally runs at app install. The device data source process runs on every media add, update, delete. Affected Album file is updated and All Media file created by concatenating all files. Process is restarted on any change and can leave All Media or an album in error. Some OS updates and App media adds can change All Media ID. This indexing can be implemented using database, lists & arrays, object oriented. The code implementation is as follows:
1. Find All Media file ID 141: Correct when largest file count>=sum of file counts. Try to complete in 3 attempts or a 1 second delay and retry.
2. Build multiple items INSERT statement when step 1. is true. If error persists, advise user try again later a. Execute INSERT INTO table (field1, field2, . . . )?,?,? [(1), (2), . . . ]
3. HOME page display 144, start async Daily Memory indexing. Calendar indexing on button tap. INDEX ALL novel code to display Home page with media<10 seconds after app install
Database media table usage
   Home page: uses prime key row ID (current date) and tag filtering for fast scrolling through device media
   Album/folder/favorite: orders by creation date, fast selecting a media set from table scan
Media table: has constant additions/deletions/updates, all access is prime key ID
   Table fields: ID prime key auto-increment, date, description, tag, media ID, type.
   INSERT optimum number of records at a time, ALL would be fastest but SQL text 1 MB maximum & text construction slows rapidly as text length grows making 500 typically near optimum
   Home page fastest using Prime key sequential access with LIMIT optimum page size & OFFSET
Data source files: camera, recent, screenshots, thumbnails, each app adding media from any source
   Fast access: media ID, current date, type (photo, video, . . . )
   10+ times slower file access: metadata including creation date, longitude/latitude
   All Media file: concatenated individual files not sorted
Indeterminate Error Conditions 143: Failure stops HOME load or incorrect order risks abandoned user
   Try {process} catch on fail {execute} used for all processing

For app install, HOME displaying photos is time sensitive: <10 seconds at 30,000 items with iPhone and Android is optimum with user displayed status

INDEX NEW media FIG. 4B runs frequently on app state changes. The device data source process runs on every media add, update, delete. Affected Album file is updated and All Media file created by concatenating all files. The process is restarted on any change and can leave All Media or an album in error. Some OS updates and App media adds can change All Media ID.
1. Sort All Media file 181, correct when last date>=stored date. If false, end process.
2. Find New media with date>stored date, verify not duplicate with cached media ID list, INSERT DB
3. HOME page verify photo exists 183, insert in display list and refresh display
Database usage, media table, source files and error handling are the same as INDEX ALL; HOME load time sub-second with iPhone and Android;

In one embodiment, the method comprises an algorithm that scans through all the directories and folders available in a device's storage. It then reads the metadata of all the photos present in these folders to identify the ones that have been recently added or created. This comparison of dates helps in not just identifying but also indexing these photos for efficient management in the media library. Indexing helps to bring structure and order to data making it easier to locate specific photos based on their creation or received dates. Since most photos today contain EXIF data, which includes the date of creation and location, this method can prove highly effective in the sustainable maintenance of a media library.

Furthermore, the proposed innovation enhances the user's control over the photos stored across varied media directories. It simplifies the process of managing a media library, reducing the time and effort required for searching and accessing a photo. The technology is compatible with all media formats and can be integrated into any existing media galleries or can function as a standalone application. Potentially, future iterations of this method may involve more complex metadata comparison for better categorization, improved user interface for efficient selection and browsing, and increased compatibility with cloud-based storage solutions. The flexibility and adaptability of this method open avenues for considerable enhancements, making it a valuable asset in the ever-evolving digital media landscape.

Complimenting this, the system also facilitates the organization of photos by assigning a ‘home album’ tag to every verified photo inserted into the database. The presence of this tag simplifies the categorization and retrieval process of the photos within the database and immediate display in the home album. This tagging system enhances user experience by facilitating quicker and more precise photo searches. Overall, the present invention advances photo data management, providing improved storage, organization, and retrieval of photo data.

FIG. 4B shows exemplary illustration of indexing processes that accelerate photo finding and for use by other processes:
Media indexing of individual and related photos can transform creating photobooks, tagging, sharing and even reducing photo clutter by hiding media FIG. 6A
   code executing calendar indexing display of media count by day 188 and the implementation is as follows:
      1. Dynamic count of media table photos for every day with link to the day's photos
      2. Respond to a day tap or process request with day's media table rows
      3. Cache the counts and links until a new media insert or time limit occurs
   code executing daily memory indexing of photo cluster activity & locations 189 and the implementation is as follows:
      1. Search media table for multiple photos within a period of time or location, a cluster, that would indicate a possible memorable activity occurred and create a separate memory table inserting a new row for each cluster and extend indexing to new media as it occurs.
      2. Respond to a cluster request with the row ID, photo links and location after using photo longitude and latitude to identify the location, timestamp the cluster as having been used and adding new information to the row.
      3. Periodically search for cluster usage in shares and photo enrichment to improve the algorithm.
   code executing feature indexing display of media by album 187 and the implementation is as follows:
      1. Feature recognition is computational intense and requires search examples
      2. Searching by album partitions the work and has another advantage of having related photos already identified. Albums have an avatar photo and options for additional training photos for search
      3. Photo search of the media table or other photo source can be initiated as a background task automatically tagging photos to the search album, results returned to a system content album for review or to another process
   code executing geographic location indexing display of media by location 190 and the implementation is as follows:

Camera photos store longitude and latitude by default but shared and downloaded photos normally have them removed. Translating longitude and latitude into meaningful named locations is usually done by cloud services with large databases.
1. This device local method uses a table on the device of longitude and latitudes for countries, states, major cities and popular destinations to select the three closest points and by distance from and direction to the points, determine the country, state of larger countries and for small distance separations, city or popular locations. As an alternative, linking to a network implementation can add unlimited precision.
2. The algorithm uses location frequency to determine a home location and surrounds it with a grid.
3. For locations outside of the home grid, the table is used to quickly identify location and uses photo cluster activity's locations to increase the confidence of the answer.
4. The location table and access can improve accuracy and labeling with the user input.

Overall, each inventive method provides a strategic and organized way to streamline the storing, indexing, and accessing of photographic data. Plus, it provides a unique photobook creation feature for efficient photo presentation, potentially revolutionizing the way people interact with their photo collections.

Daily Memory 189 refers to a processing system for indexing photo cluster activity 185 in a database media table, and creating a photobook. This method primarily involves indexing the database media table into a daily memory photo. In essence, each day, the media table, which may contain a significant amount of photographic data, is indexed to extract all photo data relevant that particular day, activity or location. This indexing process is efficient, simplifying and sorting the collection, storing, and accessing of photo data on a daily basis.

The geographical clustering 190 of these daily photos forms a central part of the method. By geographically clustering the photos from the media table, we refer to the process of organizing all indexed photos based on their geographical location data. This allows one to create collections of photos that have a geographical context, which can be used to create representative albums or enhance the browsing experience for users seeking specific, location-based photos.

A crucial aspect of this methodology FIG. 6H is the creation of a new photobook based on the indexed and geographically clustered photos. Once the photos have been gathered and organized accordingly, they are then compiled into a photo ribbon organized chronologically. This photobook provides an organized collection of photos in a virtual book format, where each “page” is essentially a unique daily memory photo.

The system also involves creating one or more daily memory photos 189. Daily memory composed photos are representative or summarizing photos clusters, typically generated from a user's collection of photos. They might contain the most memorable, high-quality, or randomly-selected photos that provide a summary of that particular day.

The addition of the daily memory composed photos to the home album is also featured in this method. The home album represents a ‘hub’ for all daily memory photos, creating a cumulative collection of these photos over time. Users can view, browse, and revisit their daily memories providing an interactive, chronologically sorted photo collection.

Furthermore, the system includes a verification process to ascertain the absence of each identified photo within the database prior to its insertion. This step eliminates the possibility of photo duplication within the database, making the system more efficient and less cluttered. Photos verified as not already present in the database in this way are then seamlessly inserted into the database. This feature improves the system's capability to maintain an updated, organized, and clutter-free photo database that optimizes storage and retrieval processes.

The system is a photo display and verification method primarily applied within digital photo album systems such as online social networks or applications. Specifically, the technical function of this system is targeted at ensuring the availability of a provided photo and facilitating the immediate showcasing of the photo in the user's home album. The innovative implementation of verifying that a photo exists before uploading and instantly refreshing the album to exhibit the new photo enhances the user interface, and contributes to the fluency and ease of the user experience of the system.

The method leverages a verification algorithm that checks the validity or existence of the photo file. This ensures the user has the assurance that the photo to be uploaded does exist before it is added to the album. If the uploaded photo is found to be non-existent, missing, or corrupted, the system notifies the user of the issue and prevents the uploading process, hence safeguarding the integrity of the user's home album. Additionally, unlike traditional systems that require manual or time-delayed refreshing, this method enhances user engagement by incorporating an automatic refresh feature once the photo is successfully uploaded.

The system also concerns the real-time update of the user's home album interface. After the successful upload and verification of the new photo, the system proceeds to automatically refresh the user's home album to display the newly added photo. It eliminates the tedious need for manual refreshes or waiting periods often seen in conventional systems and serves to provide users with a visual confirmation of their successfully uploaded photos. In summary, this patent covers an advanced method of photo display and verification that improves the user interaction and efficiency of digital photo album systems.

FIG. 5 shows exemplary illustration of processes using a tag custom datatype (TAG) to accelerate database performance and user functionality. The HOME page tag 170 is 2 characters, 2f, but a family photo could be in multiple albums, in album folders, a favorite, shared to an entire family, added to a group, chat or in a photobook. This could be 30+characters and not change performance. The Tag custom datatype enables multiple concurrent Tags, app functionality and sub-second page display with 30,000 media items on the device are benefits.

Tag Custom Datatype combines album row ID & favorite with folder, groups, chat, photobook usage into a single Tag. Multiple single Tags, separated by commas, are included. Faster performance is the result of using one database field in each media record eliminating the need for duplicates, joins to other tables, larger database size and more complex, slower SELECT qualification predicates instead of tag LIKE, 2f, for Home or, 7t, for album 7 favorites. Custom Tag also enables a single cached function with a predicate variable.

TAG uses a comma as a separator for individual tags which start with album ID followed by a single alpha character. The HOME page album ID is 2, the TAG is, 2f, and album IDs 0 and 1 can be reserved for system use. The auto-increment Album table prime key is row ID and user albums begin at 3 and rarely have more than 50 albums. The alpha characters s and t following ID normally encodes whether this is a favorite or not but other characters and meanings can be used. A comma following completes the tag or a special character denotes a variable for the TAG, such as a folder or group. It enhances performance by having a single media record text string to compare, additional display variables and a cached function with a tag variable to SELECT an “optimum page size” returning a set of media IDs. Unlike Home album, which uses the media prime key for fast sequential scrolling, the TAG selection method usually requires evaluation of every record to return the results. Using a database, this is sufficient for up to 30,000 items and by caching “media ID” results for each album scales over 100,000 items on a single device. TAG custom datatype can be implemented using a database table, with lists and arrays or object-oriented programing.

The TAG media query uses an individual album tag variable to select and return the requested media. The Album table FIGS. 9A-9B provides display name, folder names, album ID and to display albums, an optional cached media IDs. Because person albums are also used in sharing, combining tag and share activities eliminates a second album lookup. Systems albums can have a fixed, non-conflicting Tag such as the Hidden album which hides media, 1099f, (well above album IDs) and special functions like deleting hidden items from the device. Hidden items tend to be typically 2 out of 3 media on a device and deleting unwanted media saves space but also proportionally reduces photo access.

To obtain a media set for Home, an album, a photo ribbon or another function, a single cached database query using a tag variable is ready to accelerate performance. The method includes:
1. SELECT items from media where tag LIKE TagVariable.
   TagVariable that contains, 2f, would return media to Home.
   TagVariable that contains, 6f, and, 6t, would return album media items in album 6.
   TagVariable that contains, 6t!folderName, would return folder favorites
2. UPDATE a media record TAG uses a string function to add/replace an individual tag in the string;

FIG. 6A illustrates an efficient process to compose a photobook 200 on a smartphone or tablet, print at choice of publishers 254 and play multimedia version with videos embedded 270. Composing a photobook and printing it has been a technical challenge. Companies have built sophisticated proprietary laptop device tools to enable users to create a photobook, upload the photos in the book to a server where a preview is created highlighting errors and enabling the user to see what the printed version would look like. The smartphone (where the photos and videos are taken) tools normally uploaded the photos because the screen was small and the photos large. For professionals using tools like Photoshop, they could upload photoshop or pdf files to print but pdf files are extremely large because pdf photos are rasterized.

In the rapidly growing digital era, photobooks have become significant multimedia tools for sharing memories, events, and information amongst peers as a user-friendly approach to creating photobooks. The method includes the option for a user to select a photo album or a calendar, location or daily memory button to populate the photo ribbon. As a result of this selection, the user can view a chosen photos and proceed to generate a new photobook with it. This unique interface facilitates simplified navigation and a reduced learning curve for users, making the process of creating photobooks an engaging task instead of a tedious chore.

The system revolutionizes the current realm of creating photobooks by incorporating a versatile mobile application composer and publisher. Composer 200 retrieves and inserts photos into scalable encoded templates to create photobooks that are both shareable and playable entirely on a space constrained mobile device eliminating the need for network upload, servers or other connected devices. Publisher 260 uses composer's scalable encoding, reconfigurable templates and destination product specifications to create correctly sized full-page photos to upload that can also be shared to others and played as multimedia. For example, when printing a photobook, publisher eliminates, 1) using proprietary tools to create a photobook 2) uploading original photos to the producer's server and 3) proofing and finalizing the finished photobook. Instead, publisher provides a choice of leading producers that can be selected to print a photobook, then renders and uploads correctly sized, full-page rendered photos in the appropriate order which can be inserted into an empty photobook. The usage of such an advanced system optimizes processes involved in working with a photo or spectrum of photos, making it significantly efficient, speedy, and effective. The mobile application in question creates a blend of modern technological advancements and user-centric orientations, capitalizing on the accessibility of mobile devices and applications, ensuring an array of features all catered to providing seamless solutions for photo handling.

The heart of the invention operates on the premise of two intertwined features: the mobile application composer 200 and publisher 260. The composer aspect focuses on creating and developing mobile applications that facilitate photo handling. This could cover the terrain of basic tasks, like cropping, filtering or resizing, to more complex processes like photo enhancement, recreation or modifications. The platform's user-friendly interface assists both tech-savvy users and technophobes alike. The publisher, as the name suggests, opens avenues for the photos to be published on various platforms, respective app stores or as separate entities, reprising its role as an essential gear in digital advertising, content creation, digital painting, graphics designing amongst other things.

In another aspect, as shown in FIGS. 6B-6G, the system provides a fast, versatile composer 200 that can display, add to, select & hide used ribbon photos 230 and turn them into a beautiful, individually composed photobook and the publisher transforming it to print it at almost any publisher 250. In addition, the composer can create a playable multimedia slide show version for this device or others and optionally add videos and multimedia items to the book for a playable multimedia version 270. The Index-enhanced photo ribbon 230 finds related photos, finds a missing photo, hides used photos saving scrolling time. Media compress/crop makes ribbon scrolling and photo placement 210 run faster without any delay. Users can instantly preview 240 changes with Immediate rendering because the canvas using a reconfigurable template is typically 0.2 megapixels.

FIG. 6B shows an exemplary illustration of composer and publisher, which enable users to create composed photobooks and print them at photobook publishers by composing, rendering and uploading page photos on a space constrained mobile device.
offering to said user an option of
adding, removing and replacing a template, photos, text and background
adding and deleting pages and rearranging page order
wherein changing a page template is offered by tapping a button and then the new template
wherein adding or replacing a photo in the template is offered by tapping the template photo slot and the ribbon photo
wherein placed photos are hidden in the ribbon and replaced photos are unhidden
wherein photo sizing and positioning are offered by two-finger touch movement
wherein adding, updating and deleting text and text properties is offered by tapping a button or placed text, making changes and saving
where text positioning is offered by drag and drop
wherein page navigation and adding pages is offered by tapping a button
wherein reordering pages is offered by tapping a button and selecting the new page position
wherein navigating pages is offered by tapping a button for adjacent pages and adding a page to the end
wherein changing background is offered by tapping a button
wherein adding new photos to the photo ribbon is offered by tapping a button
wherein printing at a publisher is offered by tapping a button;
code for executing user options, page assigned button gesture detectors execute processes with conditional logic, pass page state, variables and context to called processes, return variables from called processes with completion codes, then reset;
detectors include:
template slot detector tap adds highlight to slot, activates photo ribbon image buttons, receives image ID from selected photo tap and activates photo to image controller, hides photo in ribbon and resets for a photo tap to change the photo;
template slot image controller accesses original photo from ID, positions image in slot, returns position and scale values and sets detection for a pan size and position adjustment;
text detector button or text on canvas tap invokes popup to add or change text and text properties, recalculate text display, positions text on canvas in existing position or default position for new text and sets text controller to tap or pan detection for dragging and dropping text.
background detector tap invokes popup with color, texture and options to change, recalculates the bitmap and displays;
page delete detector removes page encoding renders the new current page;
page position detector invokes a popup with existing page number and new position options, repositions page encoding to new selected position;
template change detector unhides photos in ribbon, resets page encoding to new template ID;
code that changes the canvas or photo ribbon initiate a page render after updating encoding;
code executing a canvas change of adding a photo, adjusting photo scale and position, adding text, dragging and dropping text, background change and photo ribbon scrolling performs: encoding update from photo, text, background and scrolling controller's returned data, canvas layout and photo ribbon display position calculated, bitmap is rendered for canvas and photo ribbon and bitmaps included in page rendering;
code executing a photo placement or panning adjustment of position and scale performs: gesture detector invokes access original photo, the photo controller positions photo to fill slot with default encoding of scale=1 and position offsets (0,0) and for photo scale and position adjustment, photo controller returns adjusted offset and scale values to encode;
code executing a text add, update and positioning performs: gesture detector invokes a popup to enter text, select font, size and other text formatting options, text controller positions text on canvas and position adjustment is drag and drop with text controller returning new position value on the canvas and encoded;
code executing a background change or feature add performs: gesture detector invokes a popup to make change of color, texture or other feature and background controller returns selection for encoding;
code executing other buttons for adding photos to the ribbon, changing page position in photobook, deleting a page, changing template, rendering a photobook or page, printing a photobook performs: invoking a popup, displaying selection options, executing the selection and returning the values for encoding;

FIG. 6C illustrates an example of how this invention improves performance which can run, in this example, over twice as fast and the uploaded page photos are saved as playable multimedia and encoding is multimedia extensible and reusable for another project. A typical printed photobook contains 30 pages (publisher minimums are usually 20) including the covers, has 75 photos used to create the pages out of 100 photos selected by scrolling through the gallery of all photos on the smartphone and usually selected with proprietary publisher software. The most user elapsed time consumed in creating a photobook is usually 1) finding and selecting the photos, 2) uploading the photos to the publisher, 3) dragging-and-dropping of templates from other pages and 4) dragging-and-dropping photos to the current template. The most CPU consuming processes are scrolling to find the photos, rendering photos, drag-and-drop photos, uploading photos and creating a print ready preview. This invention reduces elapsed time and speeds up processing by replacing scrolling with button taps of pre-indexed photos by calendar date, location and daily memory photo and by replacing drag-and-drop of templates and photos with button taps and by reducing composer rendering time with reconfigurable templates, scalable encoding and photo ribbon of compressed original photos and by reducing upload time by uploading a single photo per photobook page and not uploading original photos.

FIG. 6D shows an exemplary illustration of composer and producer, which enable users to compose both printed photobooks and produce playable multimedia file types from the same project encoding by using reconfigurable templates and scalable encoding on a space constrained mobile device.

FIG. 6E illustrates reconfigurable templates and scalable encoding usage. Starting with template choices 216, they are scaled to display multiple templates on a page scrolling to the next page if needed. In the composer 218, templates display scaled to the canvas size of the device and have adjustable border size which resize and position of the photo slots and text. In publisher choice 212, templates are reconfigured to the publisher book specifications including the printing trim and bleed. Finally in playable multimedia 214, template page and slots adjust to videos and other multimedia types.
code executing to offer to said user an option of shape: portrait, square, landscape and project defaults settings: photo source album or indexing, font, page border width;
code to execute user options performs: invoke page with options, add selections to encoding and start composer;

FIG. 6F illustrates reconfigurable templates parameters of change 222. As illustrated, reconfigurable templates provide control over template choices, baseline canvas, border width, product, publisher choice:
code to execute placement of composer scaled to fit device display and return page and canvas height, width to establish scaling baseline of templates: canvas pixel height & width from device, and encoding of values returned from image, text and background controllers;
code to execute rendering of composer from baseline and canvas encoding of photo size and position from relative photo slot, scale, position and absolute values from text position, background and photo ribbon position;
code to execute rendering template selection popup by scaling templates to fit grid position;
code to reconfigure template with border width selected;
code to execute publisher book size selection to print;

In another aspect, reconfigurable templates and scalable encoding speed up photobook creation and publishing, ease page template choice, simplify photo and text placement, enable an interactive photo ribbon, multimedia enhancements, and background customization, are reusable in other projects and can publish printed at a choice of publisher and multiple multimedia types from the same encoding;

FIG. 6G illustrates how template and encoding enable unique outputs for printing and playable multimedia options. The page encoding 222 device defaults are scaled to the output specifications 223 or 225 and then the photo slots and encoding are scaled to the canvas, text is scaled and positioned and any special rules are applied 224 or 226. The last step is rendering for the publisher or device 227 or 228.

FIG. 6H shows exemplary illustration of processes to immediately and automatically populate the photo ribbon 230 replacing lengthy and tedious scrolling, rearranging and finding those extra photos 236 not found or selected. This feature 237 allows users to facilitate easy searching photos, adding them to the photo ribbon and having the hidden when they have been used and sorting of photos. This process could be manual, with the user tapping a calendar date and selecting photos, or automatic using AI facial recognition or object detection, thus making the procedure more effortless and interactive. This method uses the indexing and tag custom datatype methods described previously for albums 300, calendar 150, daily memory 160, album feature recognition 165 and location 235.
code executing to populate a photo ribbon initial selection or photo addition, adding of photo IDs and scrolling performs: ordering photo IDs chronologically, adding to the display list with hide as false, accessing the photo, validating usability while compressing and cropping to a square photo ribbon format, adding to scrolling display list, position display list to first or new add, calculating display layout, rendering ribbon bitmap, scroll controller managing page display and photo positioning;

The method as set forth provides a more robust and efficient feature in photobook management. The ingenious integration of a media table and calendar 150 display delivers an advanced level of convenience to users managing their visual documents. The combination of the indexing system, calendar display, and photo tagging signifies a significant step forward in the digital management of photobooks.

A standout feature of the invention is its ability to manage photos in multiple photobooks concurrently. This means a user doesn't have to access each photobook separately but can view and manage photos from different photobooks within the same display. Having the ability to pull together photos from various photobooks offers a more streamlined approach to manage and organize photos effectively.

FIG. 6I shows exemplary illustration of processes how this invention radically changes the model to completing composing, proofing and rendering on the smartphone, including a continuous print-ready preview 240 for every addition and change. When satisfied with the creative process, the user can select from any publisher to print a book FIG. 6J, and can create a multi-media version FIG. 6L for the user's smartphone, laptop or other device. Based on the desired output, photos, a video or multimedia files are created for a specific target.

Print-ready preview is displayed continuously by scaling the template 242 to the device canvas and photos, text and background are placed on the canvas. Code to execute print-ready preview operates as when a canvas change is rendered and the publisher reconfigures preview to the selected photobook size and publisher printing rules to print as displayed in the preview. Rendering to device canvas size, compression of photos to photo ribbon size, and memory caching reduce rendering computation 248 to milliseconds.

FIG. 6J shows exemplary illustration of processes that use the publisher book 251 size, covers and print trim & bleed and other rules from the publisher web site to render a page photo that, when viewed in the printed book, will closely match the continuous preview;
code to execute publisher retrieval of selected publisher and book size and printing specifications from printing table;
code to reconfigure the page template for printing: first to the book size height: width by scaling factors photobook/baseline, then using trim, bleed and gutter dimensions to create an inner template with photo slots scaled. For photo slots whose sides are on the inner template border, increase the width or height to the outer temple border and increase the photo offset half that value away from the template border and position the photo with adjusted encoding. For other photo slots, position photos with existing encoding. to position text, use inner template scaling factors to scale top and left offset values and the font size and for background, the outer template;
code to execute rendering of publisher photobook adjusted page canvas;
code to execute sending to a publisher an order and uploading page photos to print said printable product wherein after said printable product is printed it becomes a delivery item on behalf of said user who placed said print order;

FIG. 6K shows exemplary illustration of the system with additional publisher outputs for another device, a photobook publisher, cast to TV, photo player can be produced from the same project. The creation of an additional outputs is 10 times faster than a new project. Outputs include a share to another device 262, a photobook publisher 264, an automatically composed photobook from a set of photos 266 and a playable digital version 260 where videos, music, multimedia are added to page encoding and template. code executing to print said printable product on paper;

The method further extends to a sharing feature, where the user can share the created photobook with friends, family, or on social media platforms. This sharing could be achieved directly through inbuilt social networking integrations or by generating a shareable link, inviting more traffic and interaction to the photobook. This feature aids in personal connections and in fostering digital social interactions.

FIG. 6L shows exemplary illustration to create a playable multimedia digital version where videos 270, music 272, multimedia 271 are added to page encoding with similar methods as photos and text;
code to execute to process multimedia types such as video and audio, adding an additional slot encoding to the project;
code to execute to render a page with embedded encoding and controls for multimedia player;
code to execute processing multimedia template types with multimedia slots capable of producing movies and other playable file types

FIG. 7A shows exemplary illustration of processes directed towards an improved method of organizing, curating, and managing digital photos within a home album setting. The method allows users to select photos to tag 702, share 706, or hide 704 photos within the home album, thereby enabling greater control over the visualization and display of their digital photo content. Most important are methods to find photos fast which include daily memories and album folders 703, from the calendar or albums 705, from locations or photo feature search 707. The utility of this invention lies in its user-centric approach that maximizes user engagement and interaction with their digital photos, enhancing the overall experience of digital photo management.
code to provide automatic photo indexing, creating one or more composed daily memory photos and an interface to allow a user to display and select one or more photos to create a photobook, tag into albums, hide, and automatically compose for sharing and posting;
code to create an automatic home page displaying recent photos chronologically ordered, displaying immediately new media received by any app on the device and scrolling through recent additions and tapping buttons;
offering to said user an option of
selecting any photo or photos with a tap and another to share, compose, post, start a photobook, tag to an album, hide unwanted or play as multimedia
finding a photo or related photos by displaying photos by calendar date, location, album or activity in daily memory photo
creating a new album at any time and tagging photos as favorites and in folders
inviting friends, groups and family to use the innovation
viewing photos in a grid display and choosing other user preferences;
code for executing user options, page assigned button gesture detectors execute processes with conditional logic, pass page state, variables and context to called processes, return variables from called processes with completion codes, then reset;
detectors include:
selected photo detector tap adds highlight to photo, adds photo ID to set of selected photos, activates processing buttons, receives message from selected process, removes selection highlight and resets;
selected photo process detector tap adds photo ID to photo list, messages selected photo detector of receipt and continues processing;
photo finder detectors tap executes photo selection algorithm, displays result set of photos and activates selection and processing detectors;
add album detector tap invokes popup for entering nickname and selecting type, adds album to album table and refreshes album page display;
invite detector tap invokes popup to select type, accessing invitation text and activates send method options with invitation package;
user preferences detector invokes process to complete the action request processing;
code executing an alternate display of photos by date, location, daily memory photo, album or grid view performs: select photos by table lookup with input provided from the calling process, adding to the display list, accessing the photo, validating existence while compressing and cropping to a square photo display format, adding to scrolling display list, position display list to first, render photo bitmap, scroll controller adding to page display;
code executing a tag, hide, share, post, chat and create photobook on a selection of photos performs: gesture detector invokes process to deselect photos, calls process with selected photo IDs as input to complete the activity including optional share, post and chat automatic selection composer, update the photo's tag and returns to scroll controller refreshing the display list, positioning display list to recent, calculating display layout, rendering photo bitmap, scroll controller to page display;
code executing on create albums, invitations, set preferences and login button tap performs: gesture detector invokes a process to complete activity and returns to originating page when complete.

One implementation of the invention uses media management, searches of indexed media, smart albums for tagged media, system albums to add functionality (such as the memories album) to store composed photo links to photobook media, playable versions and daily memory media. A hidden album is a second system album to remove media display and even delete media from the device. A third system creates the photo ribbon in seconds rather than scrolling through hundreds or thousands of media which is today's standard.

The main focus of the invention involves methods that integrates a database media table into a calendar display, daily memory photos, locations you visited and facial/feature recognition for easy searching, displaying, and tagging of photos or loading a photobook photo ribbon. The concept behind this breakthrough resides in providing users with a more efficient means of finding and managing their photos through the consolidation of various functionalities such as indexing, tagging and display.

There are several novel features of the current method that make it unique in the world of digital photo organization. The first is the ability to select specific photos 702 within the home album. This feature permits users to manually choose which photos they wish to display or hide, thus empowering users to tailor their home album to their preferences. This results in a highly personalized and customized digital photo album experience.

The second feature lies in the capacity to tag photos 702 within the home album. Users can ascribe keywords or descriptors to their photos which subsequently aid in the categorization and easier retrieval of photos. Thus, by enabling users to better organize their photos through tagging, the invention facilitates streamlined navigation and photo search within the home album.

The third feature lies in the sharing function 706. The method provides the option to directly share selected or tagged photos with family, friends, or social media platforms directly from the home album interface. This integrated sharing feature promotes easy sharing of photo memories while maintaining security and privacy settings, thereby enhancing social connectivity.

The method further incorporates a hide option 704 that allows users to make certain photos within their home album invisible to others. This privacy feature is instrumental in respecting user control over their content, thereby preserving the user's sense of comfort and trust in the platform.

The user interface of the invention is simple, intuitive, and user-friendly. It has been deliberately designed to incorporate the select, tag, share, or hide features seamlessly, providing a smooth uncluttered journey for the user within the home album.

Taken together, the aforementioned features serve to optimize user control, engagement, and interaction with digital photos within a home photo album setup, thereby significantly elevating the user's digital photo management experience.

The method includes selecting a daily memory photo or a calendar button to view the photos and to create a new photobook for showing or sharing, enhances the user experience of creating photobooks. It eases the overall process while simultaneously allowing a more interactive, personalized, social, and organized way of preserving and sharing memories.

On this calendar display, photos are not just plainly displayed but are well organized. The display feature is enhanced to provide thumbnails of the appropriate pictures for each day, week, or month, depending on the user's preference. For instance, if an photo was taken or added into the photobook on a specific date, all picture would appear on that date in the calendar display.

In addition to that, the system provides a feature for tagging the photos directly from the calendar and daily memory display. Users can add tags to their photos for easy recognition and retrieval later. Users may also take advantage of this tagging function to categorize photos—for example, by event, subject matter, or people present significantly simplifying the process of finding a particular photo in the future.

Not only does the invention include the indexing, displaying, and tagging of photos, but it also offers a user-friendly interface for navigation. This feature enables users to skip or move to different dates, months, or years easily and quickly on the calendar display. This ultimately provides a more efficient way of browsing through photos and serves as a significant improvement on existing methods of photo storage and retrieval.

FIG. 7B shows exemplary illustration of processes to establish a distributed infrastructure across private network connected devices, users, families, friends and media without any stored contact information. The invitation system 754 makes the connection and synchronized album instantiation. Share and tag 752 in a single step and the recipients automatically tag 753 the photo. For families, a single invitation can connect the whole family, add all the family albums to the device and reconfigure the family 755 for each member 755. For friends, each other are 1-to-1 connected. Chat 756 with anyone and receive notifications 757 for each message that take you directly to the chat and message.

The system is delivered in the realm of digital photo management and dissemination which encompasses an innovative method for storing photos in a distributed database to update them in a family tree structure. The system prompts efficient sharing, reconfiguration, and updating of these photos. The embedded technique is specifically designed to manage a high volume of photos, found genealogically relevant or involving family history. The robust performance of the database assures swift data transactions, fortifying instant sharing amongst the users. This method enables and facilitates rapid updates and photo reconfiguration, markedly reducing the time spent in manual updates, thus augmenting overall productivity and expediting family-based discoveries or research.

This method involves the utilization of a distributed database connection, which is located on each device across different geographic locations but acts as a single system. Each component of the database manages a distinct subset of data but collaborates harmoniously with the other components, ensuring meticulous data synchronization and high fault tolerance. A family tree structure is embraced for the organization and storage of photos. Each node or a ‘leaf’ in this tree framework symbolizes individual photos or groups of photos. This structure assists with the nifty retrieval and update of photos and facilitates the incorporation of new photos or additional data into the database. This tree-structured database also encourages the rapid sharing of photos by seamlessly connecting distinct branches corresponding to different family members or relatives.

FIG. 8A shows exemplary illustration of processes to automatically expand a family based on each individual's addition and their role 400. The family table includes an id, parent, partner and children members, relationships to other families and row ids of all family members. In addition, the algorithm assigns a Global Unique ID FIG. 10 to family members. The process that creates a tree structure 420 that starts with your family and expands to your parents and siblings and your partners 430. As you add your family, new family structures for parent, partner, child or siblings with you included in your parent's family. Adding members to other families behave the same. Empty families can be hidden. Using the Global Unique ID FIG. 10 process and private network FIG. 11, each family member is assigned a unique hidden ID which is the ID that is used in the invitation process, sharing and all other distributed functions.

The family process also may allow users to create a “family” of related albums, which are automatically linked together, can be shared FIG. 8B and have an avatar and training photos for feature recognition FIG. 4B. For example, the album option may allow a user to automatically add photos to an album and/or photos by type (e.g., photos taken in the same location), by content (e.g., photos of the same subject), by time (e.g., photos taken within a certain time period), and/or by any other suitable criteria. Additionally, the user may also be able to manually specify certain parameters (e.g., keywords, categories, etc.) to link and/or sort the photos in the family. In addition, Family option may also provide a way for users to easily store, access, and/or share their photos with others. For example, Family option may allow a user to store their photos in the cloud, which may be accessed and/or shared with other users through a web-based interface or application. Furthermore, Family option may also allow a user to publish their photos in a format suitable for printing, sharing online, and/or any other suitable form of publication.

FIG. 8B shows an exemplary process for sharing the Family Tree to other family members. A family member sends an invitation to selected members. When the recipient enters the correct security codes, the family tree is displayed with families and nicknames, and the recipient selects their nickname. The tree is reconfigured 458 for the person's view, roles are changed and albums created for each family member. They can expand their family tree independently from what they received and also hide unnecessary members or families.
code executing to send an invitation performs: invoking a popup requesting invitation type of family, friend or group and prepares a family, friend or group invitation with network credentials that can be communicated by the user to recipients via any user method, is encrypted and uploaded to network invitation management with sender user ID and family structure and family member IDs or group ID to the network for acceptance by logged in recipients. An accepted invitation by a friend adds an album with sender ID and nickname and network connects the two users.

The system is beneficial and streamlined with chat, sharing and updating of photos for families and groups.

An accepted invitation by a family member, reconfigures the family tree for the accepting member, adds for each family member, an album with member ID and nickname for 1-to-1 sharing and a family ID album on the device and network for 1-to-many sharing and the network connects all logged in family members. As others receiving the invitation accept and login, they are also connected. An accepted invitation by a group invite adds an album with the group ID and nickname on the device and connects the members 1-to-many to the shared group network album. Both network albums send notifications to members with messages and album additions.

FIG. 9A shows exemplary processes and information included in Smart Albums. Smart albums have two album categories: user and system. User albums are stored in an table with the first entry for the app owner and others added by that person. The user table has a row id, type, album id FIG. 10, nickname, folder names, avatar photo and optional metadata that can affect functionality, user preferences, album relationships, network participation and performance relationships with the device owner and themselves.

Album data used for functionality, user preferences, network and performance
ID: database row ID used in Tag Custom Datatype key
album id: GUID
Type: Friend, Interest, Pet, Family Role, Group
Nickname: changeable by every app
Family members: reconfigured on invite accepted apps
Folder names: unique to this app and device
Avatar & image feature examples: unique to this app and device
Display position: unique to this app and device
Parental controls: family tree parent role controlled
Usage: tags, shares, favorites

Code executing album updates use album row ID, shares use recipient global unique ID and tags use row ID as the key of tag custom datatype, for superior media performance and tagging to this album.

Code executing album setup on another device uses album global unique ID for this album setup. Nickname is the contact information needed to identify an album. Folder names are added by the user to an album to tag and display related media.

The album table with optional metadata can include, for example, sub-types like family, friend, pet and interest, roles like parent, grandparent, grandchild and sibling, metadata from the family tree process creating the album, display order and hidden status, network connection to the private social network. Including metadata, the album table can include:
ID: database row ID and Tag Custom Datatype ID
GUID: identical on all invitation accepted albums
type: Friend, Interest, Pet, Family Role, Group
nickname: changeable by every app
family members metadata: reconfigured on invite accepted apps
folder names: unique to this app and device
avatar & image feature examples: unique to this app and device
display position: unique to this app and device
parental controls: family tree parent controlled
usage: tags, shares, favorites;
code executes a popup to receive nickname, type to create the album with a global unique ID and other fields. Additions and changes, such as adding an avatar image, folder names, alternate display position and hide update the album fields;

Smart albums include family tree members, which have many to many connections. friends who have a 1 to 1 and interests that are private to the user and pets which can be shared or exclusive. Group albums have many to many connections moderated by the group originator and all have a synchronized group album. Smart albums have important data that affects functionality, preferences and photo display conditions. The album ID is the key for Tag Custom Datatype and also contains the GUID which is the key for distributed functions.

Adding an individual album is also an example of an automated photo collection option. As described above, the user may select Add Album option to cause a system (e.g., server) to search for photos related to a specific topic, photo feature or event. The system may use an automated search algorithm (e.g., Google Image Search) to locate images on the Internet that are related to the selected topic or event. The system may then automatically collect and organize the images into an album, which may be stored in a database. The user may be able to specify the parameters of the automated search, such as the search terms to use, the time period of the search, etc.

FIG. 9B shows exemplary processes with Systems Albums, which are exclusive to the user and device. Each has a nickname, tag, unique features and roles. The Home 322 album tag is created during indexing FIG. 4A, updated in tagging to albums FIG. 5 and used to display media in an album FIG. 9A, system or temporary album FIG. 9B, a photo ribbon FIG. 6H or in another function. Other system albums such hidden 326 contents 328 and memories 332 also have unique functions and tags.

Album Type determines album features, preset tag is system assigned
Fixed Tag: home, 2f,
GUID: assigned but not used
Type: Home, Hidden, Contents, Memories
Nickname: Fixed
code executing setup of system albums occurs at initial installation each with a preset tag value and nickname;

Album Type determines album features implemented with user option buttons when album is selected and viewed;
Fixed Tag: home, 2f,
GUID: assigned but not used
Type: Home, Hidden, Contents, Memories

A hidden album 326 contains media tagged as not needed (duplicates, quality issues, etc.) and media can be deleted from the device. Contents 328 displays media used temporarily such Calendar-date, Daily Memory and Add to Photo Ribbon. Finally, Memories 332 has printed and playable photobooks and Daily Memory photos.

FIG. 10 shows exemplary illustration of processes to shows that a Global Unique ID (GUID) could be used by an app or family of apps, by a person, individuals, an organization or multiple organizations. The ID would be generated by random number and validated as unique by a central server 502 or redo requested. An GUID is associated to app, person and device. Use can be verified by biometrics, multi-factor authentication without having any contact information or with more traditional account/password. The ID 500 is a 64 bit integer which has 18,446,744,073,709,552,000 values in implementations thereof. The system can handle eight billion people (8,000,000,000) people even with multiple IDs. A second usage model 526 (and example) assigns blocks of numbers to an entity who has an algorithm to create unique IDs within their block of IDs. Uniqueness is validated at initial network login, changed if invalid and errors reported to the delegated block algorithm owner.

In order to provide an unmatched level of security, the GUID is used instead of any contact information. This important feature eradicates the possibility of unauthorized access to personal data, thereby ensuring the comprehensive protection of the user's identity. Moreover, the global identifier itself is concealed and is not readily revealed. The method strategically reinforces data protection measures, making it highly resistant against hack attempts aiming to access and exploit personal contact information. Thus, its safeguarding abilities are not just limited to the individual photos, but extend to protect the sensitive private information associated with the data.

In addition to the high security levels, the method also provides a streamlined way of handling data. The storage process follows a well-defined, systematic, and easy-to-implement procedure that assigns the global identifier to each photo during the storage process. Thus, the system is not only capable of maintaining high-level security but also ensures smooth operation and user-friendly interaction. The method thus bridges the gap between robust security measures and efficient operational capabilities, creating an optimal system for secure data storage and retrieval. It essentially transforms the way data privacy and security are approached and handled, making it a landmark method in the realm of secure digital photo storage.

FIG. 11 shows an exemplary illustration of processes for Private Social Network 600 that uses multi-factor authentication 650, and provides user anonymity for GDPR compliance by using nicknames. The distributed database 610 of albums and media with global unique ID prevents unknown senders, fake notifications and spam with invitation-based connections 620, uses temporary storage for notifications 630 and shared media until downloaded by recipient, uploads media for group sharing and prevents disruptions by device failure and adds new devices with database backup 640. Another Privacy benefit is GDPR compliance.
code executing automatic assignment of global unique ID for a user ID;
code executing user ID uniqueness verification or assigning a unique value at network login;
offering to said user an option
adding a button to login to the network
wherein activating network services is offered with successful network login
wherein sending and receiving messages, media, invitations and notifications is offered by tapping a button
wherein creating network sharable albums and uploading media is offered by tapping a button
wherein restoring an automatic database backup to the device is offered by tapping a button
code for executing user options, page assigned button gesture detectors execute processes with conditional logic, pass page state, variables and context to called processes, return variables from called processes with completion codes, then reset;
detectors include:
send-accept invitation detectors tap sending and receiving invitation using sender provided message and system provided credentials and acceptance by entering credentials to establish private connections with sender and other recipients by exchanging user IDs
restore database detector tap downloads backup file, decrypts, deletes current and restores backup group create detector tap creates network sharable group album and enables media upload
sending notification including a message containing a text message, advice of media shared or a videocall, group and chat activity is automatically sent to a connected recipient
receiving notification detector automatically processes notification if app state is active or background and if closed, notification is displayed, alerted and tap loads app to process notification
code executing a user login performs: invoking a multi-factor authentication popup requesting a phone number to receive a code, when entered, sends to the private network the number, app owner automatically assigned global unique ID and the device ID, wherein the network verifies the requesting user ID is unique and if unique, sends the code to enter and complete the login. If not unique, a unique number is returned and automatically updated with code to complete login. if the code is entered from another device, the login is aborted;
code executing to send an invitation and accept an invitation performs: invoking a popup requesting invitation type of family, friend or group and prepares a family, friend or group invitation with credentials that can be communicated by the user to recipients via any user method, is uploaded with user ID and family IDs or group ID to the network for acceptance by recipients wherein acceptance by a logged in user with the correct credentials adds friend, family or group albums included in the invitation and connects user to those albums if they are logged in;
code executing send and receive notifications to other connected users performs: invoked by process creating a message, message type and recipients IDs, constructs message adding timestamp, sends message to network receiver code, receiver code uses type to construct notification content from type to each recipient, looks up recipient device ID and sends to recipient device which receives the notification and depending on app status displays the notification and alert sound and on tap, starts the app, brings app in background to active and presents notification to app notification receiver code which invokes processes based on message type;
code executing share media to recipients and store media in the network performs: invoked by process creating send notification with type including media IDs, media is uploaded to the network and when complete, network adds media IDs to recipient download media queue and sends notification to recipients' media available to download wherein media network normally retains media until it is downloaded by all recipients unless retention is set to true for a group;
code executing add message or with media to chat and start videocalls with individual, multiple individuals, families and groups performs: invoked by process creating send notification with type chat or videocall with chat ID or session ID and uses send notification and send media;
wherein code executing to backup data to the network performs: invoked by add or update albums, creates a snapshot, encrypts and uploads to network automatically and backup id added to user ID metadata wherein restore backup initiated by user downloads and replaces existing table wherein all other table backup is performed periodically, uploaded and added to user metadata.

The system pertains to an innovative method of storing digital photos in a manner that ensures data privacy and security. This method involves the use of a global identifier which is both unique and secret, serving as the distinguishing mark for each photo, thereby augmenting the integrity and confidentiality of the stored data. It does this by assigning each photo a singular and concealed global identifier upon storage, thus avoiding any breaches of private contact information, which is a major concern in various sectors where data privacy is of utmost importance. This method significantly enhances operational efficiency and security during data transfer as the photo is cryptographically tagged with the global identifier, thereby reducing the chances of data loss, theft, or distortion.

The system pertains to a novel method that incorporates the storage of photos in a distributed database. This innovative method provides a robust solution for managing large scale datasets of photos, overcoming the limitations faced by traditional database management systems in terms of data scaling, read and write throughput, and latency.

In the implementation of the invention, there's integration of algorithms and computational structures that enhance the efficient storage and retrieval of the photos in the distributed database. The database comprises numerous nodes or clusters wherein each one can handle a significant number of photos for each device. Thus, enabling its immense capability of handling a minimum of 30,000 photos per device. The high-capacity storage and data processing capability will vastly improve the photo management landscape for various applications ranging from scientific research, healthcare, digital marketing, social networks to surveillance systems.

This method of storing digital photos is not only technologically advanced but also offers numerous advantages over traditional methods. Firstly, it enhances the response time due to the distributed nature of the database, each device has direct access to its set of photos, thereby reducing retrieval times. Secondly, it is highly scalable making it a formidable solution as the demand for photo data storage increases. Lastly, the reliability and availability of the database are raised considerably due to the distributed architecture design. The method provides data redundancy by storing photo copies on different nodes, hence, even in the event of a failure, the data remains available. Henceforth, it revolutionizes existing data storage methods by ensuring high capacity, high availability, and efficient photo data management.

The system addresses the persistent issue of privacy and compliance with respective international regulations for users in a social network environment. It includes a privacy method and system for sharing photos in a General Data Protection Regulation (GDPR) compliant private social network. The system uniquely combines user-friendly features of a social media platform with increased privacy settings and stringent compliance with GDPR. The primary objective of the invention is to foster a user-friendly environment where individuals can share photos and connect with others while assuring their data privacy and adherence to GDPR rules in the European Union and possibly beyond.

Privacy stands as a central pillar in this invention, allowing the users to control who can view and interact with the photos. Users can choose to make the photobook posted to social media or make it accessible to specific connections. They can also control copy permissions, ensuring a safe and secure environment for their memories.

In detail, the invention features a platform where users can upload, share, and view photos. This platform has a unique focus on privacy that is compliant with the GDPR. Users can upload their photos, which are then stored securely, ensuring proper handling and storage of user data. The invention also provides a feature to control who can view and interact with the shared photos, adding another layer of privacy. The controls coded into the system, such as consent request prompts and clear declarations about how user data is processed and stored, ensure that all activities comply with GDPR regulations. The platform also incorporates several security measures such as encryption of user data and a secure server to store data. A media distributed database is created by a composite key of media creation date and uploading global unique user ID enabling sharing, media ownership and fast access.

By creating a GDPR compliant private social network, this invention introduces a paradigm shift from conventional social networks. It not only respects users' privacy rights and ensures adherence to GDPR. It is designed not only to satisfy the growing concerns over online privacy but also to cater to the specific needs of those living in jurisdictions where GDPR is applied. The platform's ability to allow users to share photos while maintaining stringent privacy features addresses the increasing desire for social media platforms that focus on privacy and uphold regulatory compliance. With this invention, users can freely and safely engage, ensuring they have control over their personal data and photos with increased efficiency and performance. The private social network uses anonymous user global IDs and invitations offered and accepted to protect user identity, privacy and personal media and wherein network services are used by logged in users with multi-factor authentication and wherein invitations enforce user to user, store and forward connections,

Lastly, despite the sophistication of the network and the method to store digital photos, it is scalable and can be applied across different operating systems and digital devices, including smartphones, tablets, laptops, and desktops. The robustness of this method lies in its flexibility and adaptability, making it a versatile tool for digital photo organization across diverse user bases and technological platforms.

The essence of this invention lies in its adaptability and wide-scale usability. Its ability to be incorporated in Android, IOS, MacOS, Windows and Chrome platforms make it all-encompassing. Additionally, it can serve amateurs who want to edit photos for their private collection and professionals in the arena of digital marketing, photo enhancing companies, photo journalistic enterprises, etc. It is also useful for app developers who want an integrated platform for creating and publishing their apps that handle photos. By providing a centralized, streamlined process for photo handling on mobile devices, this invention brings together technological innovation, advanced functionality and user-oriented design into one complete package.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

While there has been shown several and alternate embodiments of the present invention, it is to be understood that certain changes can be made as would be known to one skilled in the art without departing from the underlying scope of the invention as is discussed and set forth above and below. Furthermore, the embodiments described above are only intended to illustrate the principles of the present invention and are not intended to limit the scope of the invention to the disclosed elements.

1. A method of creating a printable photobook without uploading to the publisher photos used to create the photobook, the method offered by a mobile user device having a mobile device operating system, the method comprising:
code to provide an interface to allow a user to create a photobook project with a name and portrait, landscape or square layout and a plurality of photos for the photo ribbon of said user device;
code to create an automatic composer page with a canvas template, a preview rendered by the device, and selected photos in a photo ribbon chronologically ordered and buttons;
code to offer to said user an option of adding, removing and replacing a template, photos, text and background;
code for adding and deleting pages and rearranging page order;
wherein changing a page template is offered by tapping a button and then the new template;
wherein adding or replacing a photo in the template is offered by tapping the template photo slot and the ribbon photo;
wherein placed photos are hidden in the ribbon and replaced photos are unhidden;
wherein photo sizing and positioning are offered by two-finger touch movement;
wherein adding, updating and deleting text and text properties is offered by tapping a button or placed text, making changes and saving;
where text positioning is offered by drag and drop;
wherein page navigation and adding pages is offered by tapping a button;
wherein reordering pages is offered by tapping a button and selecting the new page position;
wherein navigating pages is offered by tapping a button for adjacent pages and adding a page to the end;
wherein changing background is offered by tapping a button;
wherein adding new photos to the photo ribbon is offered by tapping a button;
wherein selecting a book size and publisher to print the book is offered by tapping a button to render correctly sized, full-page photos and option of sending to a publisher an order and uploading page photos to print said printable product;
code to print said printable product on paper, wherein after said printable product is printed it becomes a delivery item on behalf of said user who placed said print order;
code executing a canvas change of adding a photo, adjusting photo scale and position, adding text, drag and drop text, background change performs: encoding updated from photo, text and background controller data, canvas layout calculated, bitmap is rendered for canvas, including canvas bitmap in page display rendering;
code executing a photo ribbon initial selection, adding of photo IDs and scrolling performs: ordering photo IDs chronologically, adding to the display list with hide as false, accessing the photo, validating usability while compressing and cropping to a square photo ribbon format, adding to scrolling display list, position display list to first or new add, calculating display layout, rendering ribbon bitmap, scroll controller adding to page display;
code executing a photo placement or adjustment of position and scale performs: gesture detector invokes access original photo, the photo controller positions photo to fill slot with default encoding of scaling and position offsets and for adjustment, photo controller returns adjusted values to encode;
code executing a text add, update and positioning performs: gesture detector invokes a popup to enter text, select font, size and other text formatting options, text controller positions text on canvas and position adjustment is drag and drop with text controller returning new position value on the canvas;
code executing a background change or feature add performs: gesture detector invokes a popup to make change of color, texture or other feature and background controller returns selection for encoding; and
code executing other buttons for adding photos to the ribbon, changing page position in photobook, deleting a page, changing template, rendering a photobook or page, printing a photobook performs: invoking a popup, displaying selection options and returning the selection for encoding.

2. The method of claim 1, wherein said scalable encoding comprises encoding said plurality of photobook pages, said plurality of selected photos, said page template ID, template slot photo ID, scale, position offset, template background, said plurality of template text, font, and relevant locations and sizes thereof.

3. The method of claim 1, wherein said reconfigurable templates comprise selections for covers, individual pages and opposing pages, each with canvas relative height and width and photo slots relative height, width, position from top, left and right, wherein templates render device template choice grid, device canvas display, device player or alternate and publisher's book size and print specifications and in addition, said photo slots adjust height, width, photo position and scale.

4. The method of claim 1, wherein said photo ribbon accept initial selections of device photo IDs from albums, indexing or other method and add additional photos from different sources.

5. The method of claim 1, wherein a print-ready preview is rendered for composer additions or changes.

6. The method of claim 1, wherein publisher book sizes and printing specifications are obtained from publisher's web site to render correctly sized, print-ready page photos.

7. The method of claim 1, wherein rendered, full-page photos upload to publisher's web site photo upload URL.

8. A method of processing photos for display and selection to create a photobook, to tag into albums, to hide and to share, post and play as multimedia, the method offered by a mobile user device having a mobile device operating system, the method comprising:
code to provide automatic photo indexing, creating one or more composed daily memory photos and an interface to allow a user to display and select one or more photos to create a photobook, tag into albums, hide, and automatically compose for sharing and posting;
code to create an automatic home page displaying recent photos chronologically ordered and buttons;
code to offer to said user an option of
displaying indexing-related photos by tapping a calendar date, location or daily memory photo;
creating a selection by tapping one or more displayed photos;
initiating processes with a button tap and selection as input to:
create a photobook;
tag to an album,
hide photos,
share or post photos,
compose a selection to share or include in a chat or social media post wherein the selection of photos is replaced with one or more populated, composed pages ready to send;
creating user albums;
setting user preferences;
logging in to activate social network services;
wherein code executing an alternate display of photos by date, location, daily memory photo or grid view performs: select photos by table lookup with input provided from the calling process, adding to the display list, accessing the photo, validating existence while compressing and cropping to a square photo display format, adding to scrolling display list, position display list to first, render photo bitmap, scroll controller adding to page display;
wherein code executing to select photos performs: gesture detector calls process with photo ID, selected indicator added to the photo and rendered, new bitmap replaces old in scroll controller to display;
wherein code executing a tag, hide, share, post, chat and create photobook on a selection of photos performs: gesture detector invokes process to deselect photos, calls process with selected photo IDs as input to complete the activity including optional share, post and chat automatic selection composer, update the photo's tag and returns to scroll controller refreshing the display list, positioning display list to recent, calculating display layout, rendering photo bitmap, scroll controller to page display;
wherein code executing on create albums, set preferences and login to social network services button tap performs: gesture detector invokes a process to complete activity and returns to originating page when complete.

9. The method of claim 8, comprising indexing wherein at installation, all device media are indexed chronologically into a media table with a home album tag and after installation, all new device media added to the table and tagged without creating duplicates.

10. The method of claim 8, comprising calendar date wherein all media table entries are indexed by calendar date with media count and links to the day's media.

11. The method of claim 8, comprising location wherein all media table entries are indexed by location with links to the day's media.

12. The method of claim 8, comprising daily memory wherein media table entries are indexed by photo activity clusters, composed in the home album and displayed with links to the daily memory's media.

13. The method of claim 8, comprising smart albums wherein system albums are created automatically and user albums have metadata and are added by the user at any time and media is also tagged to the album in folders and as favorites.

14. The method of claim 8, comprising tag custom datatype wherein all media is tagged to one or more albums with tag separators and individual albums' tag that contains metadata such as folder ID, favorite status and special album encoding.

15. A system for messaging and sharing photobooks, photos and information to family, friends and groups, the system comprising:
one or more mobile user device having a mobile device operating system coupled to the network;
a database coupled to the network to receive user multimedia content and other data from the one or more user mobile devices;
a processor coupled to the network;
a plurality of computer codes embodied on said processor, said plurality of computer codes which when executed causes said processor to execute a process to login user with multi-factor authentication enables said user to send invitations and accept with credentials to connect users and add said user connections to network database with services enabled;
wherein connected users send, receive and forward notifications to one or more users;
wherein connected users send media, store in the network database, indexed and notification sent to one or more users;
wherein connected users start chat and videocalls;
wherein logged in user backup data received and returned to a user device;
wherein code executing a user login performs: invoking a multi-factor authentication popup requesting a phone number to receive a code, when entered, sends to the private network the number, app owner automatically assigned global unique ID and the device ID, wherein the network verifies the requesting user ID is unique and if unique, sends the code to enter and complete the login. If not unique, a unique number is returned and automatically updated with code to complete login. if the code is entered from another device, the login is aborted;
wherein code executing to send an invitation and accept an invitation performs: invoking a popup requesting invitation type of family, friend or group and prepares a family, friend or group invitation with credentials that can be communicated by the user to recipients via any user method, is uploaded with user ID and family IDs or group ID to the network for acceptance by recipients wherein acceptance by a logged in user with the correct credentials adds friend, family or group albums included in the invitation and connects user to those albums if they are logged in;
wherein code executing send and receive notifications to other users performs: invoked by process creating a message, message type and recipients IDs, constructs message adding timestamp, sends message to network receiver code, receiver code uses type to construct notification content from type to each recipient, looks up recipient device ID and sends to recipient device which receives the notification and depending on app status displays the notification and alert sound and on tap, starts the app, brings app in background to active and presents notification to app notification receiver code which invokes processes based on message type;
wherein code executing share media to recipients and store media in the network performs: invoked by process creating send notification with type including media IDs, media is uploaded to the network and when complete, network adds media IDs to recipient download media queue and sends notification to recipients media available to download wherein media normally retains media until it is downloaded by all recipients unless retention is set to true;
wherein code executing add message or with media to chat and start videocalls with individual, multiple individuals, families and groups performs: invoked by process creating send notification with type chat or videocall with chat ID or session ID and uses send notification and send media;
wherein code executing to backup data to the network performs: invoked by add or update albums, creates a snapshot, encrypts and uploads to network automatically and backup id added to user ID metadata wherein restore backup initiated by user downloads and replaces existing table wherein all other table backup is performed periodically, uploaded and added to user metadata.

16. The method of claim 15, comprising a private social network wherein anonymous user global IDs and invitations offered and accepted protect user identity, privacy and personal media and wherein network services are used by logged in users with multi-factor authentication and wherein invitations enforce user to user, store and forward connections.

17. The method of claim 15, comprising a global unique ID for users and albums, wherein users and albums are assigned an ID that is a hidden 64 bit integer verified unique by the network at initial multi-factor login in conjunction with device ID and network routing and used by the invitation to establish connections and a distributed album database.

18. The method of claim 15, comprising a media distributed database, wherein the global unique user ID and 64 bit media creation date form distributed database ID.

19. The method of claim 15, comprising code for invitation management, wherein a user creates an invitation uploaded to the network for individuals, family members or group members using nicknames and network credentials to send to invitees for them to access the network invitation where acceptance and selection of their nickname to connect participant to sender and exchange albums.

20. The method of claim 19, comprising groups and families, wherein accepted family invitations create point to point connections for 1-to-1 sharing, add albums for family members and a family album on the device and in the network and 1-to-many sharing, wherein groups have a group album for 1-to-many sharing.
